(19) United States
(12) Patent Application Publication
(10) Pub. No.: US 2019/0235316 A1
(43) Pub. Date: Aug. 1, 2019

(54) POLARIZING PLATE AND LIQUID CRYSTAL DISPLAY DEVICE

(71) Applicant: FUJIFILM Corporation, Tokyo (JP)

(72) Inventors: Daisuke SASAKI, Kanagawa (JP); Nobutaka FUKAGAWA, Kanagawa (JP); Naoyoshi YAMADA, Kanagawa (JP); Mayumi NOJIRI, Kanagawa (JP)

(73) Assignee: FUJIFILM Corporation, Tokyo (JP)

(21) Appl. No.: 16/374,080

(22) Filed: Apr. 3, 2019

Related U.S. Application Data
(63) Continuation of application No. PCT/JP2017/036391, filed on Oct. 5, 2017.

(30) Foreign Application Priority Data
Oct. 5, 2016 (JP) 2016-197613

(51) Int. Cl. G02F 1/1335; G02B 5/30; G02B 5/22; C09B 57/00; C08J 5/18

(52) U.S. Cl. CPC G02F 1/133528; G02B 5/3025; G02B 5/223; C09B 57/007; C08J 5/18; C08J 2345/00; G02F 2202/04; G02F 2202/28; G02F 2202/022; G02F 2001/133567; C08J 2301/10; G02F 2201/50

(57) ABSTRACT

Provided are a polarizing plate having a polarizing plate protective film having a thickness of 20 μm or more disposed on both sides or either side of a polarizer through an adhesive layer, in which at least one of the polarizer, the polarizing plate protective film, or the adhesive layer contains one or more dyes having a main absorption wavelength range of 480 to 510 nm or 580 to 610 nm and a liquid crystal display device having this polarizing plate disposed downstream in a light emitting direction of light that is emitted from a backlight unit.

### CROSS-REFERENCE TO RELATED APPLICATIONS

This application is a Continuation of PCT International Application No. PCT/JP2017/036391 filed on Oct. 5, 2017 which claims priority under 35 U.S.C. § 119 (a) to Japanese Patent Application No. JP2016-197613 filed in Japan on Oct. 5, 2016. Each of the above applications is hereby expressly incorporated by reference, in its entirety, into the present application.

### BACKGROUND OF THE INVENTION

### 1. Field of the Invention

The present invention relates to a polarizing plate and a liquid crystal display device.

### 2. Description of the Background Art

Liquid crystal display devices are being used as space-saving image display devices having small power consumption in a broadening range of uses every year. In markets demanding high-quality images such as televisions, there is an intensifying demand for the improvement in color reproducibility as well as resolution.

Liquid crystal panels that display images are non-light-emitting elements that do not emit light, and thus liquid crystal display devices include a backlight unit that is disposed together with a liquid crystal panel on a rear surface of the liquid crystal panel and supplies light to the liquid crystal panel.

In recent years, white light emitting diodes (LEDs) have been used as light sources for backlight units. As light emitting devices using a white LED, devices in which white light is produced by mixing blue light radiated from a blue LED and light radiated from a yellow fluorescent body or light radiated from a green fluorescent body and a red fluorescent body are known. However, liquid crystal display devices comprising a light emitting device employing the above-described method have a problem in that, compared to organic light emitting diodes (OLED) and the like which are attracting attention as next-generation displays, color reproduction ranges are narrower, and there is a demand for new techniques for overcoming the problem.

In response to such a demand, JP2016-090998A discloses a method in which a coating layer including an absorbing dye and a light emitting dye is provided on a diffusion film in a backlight unit, thereby blocking unnecessary light that is emitted from a white LED. In addition, JP1997-191413A (JP-H09-191413A) discloses a polarizing plate having an azo dye in a hardcoat layer.

### SUMMARY OF THE INVENTION

However, it has been found by the present inventors' studies that, in the method and the polarizing plate described in JP2016-090998A and JP1997-191413A (JP-H09-191413A), in a case where a liquid crystal display device is lighted for a long period of time, there is a problem in that display quality (image quality) gradually degrades.

An object of the present invention is to provide a liquid crystal display device in which color reproduction ranges are wide and image quality does not easily deteriorate even in a case where the liquid crystal display device is lighted for a long period of time and a polarizing plate that is used in the liquid crystal display device.

The present inventors realized that the above-described deterioration of image quality after lighting the liquid crystal display device for a long period of time arises from the decomposition of the dye by incident light on the polarizing plate. As a result of intensive studies on the basis of the present finding, it was found that, in a case where a polarizing plate that is applied to liquid crystal display devices is provided with a laminated configuration in which a polarizing plate protective film having a specific thickness is laminated on a surface of a polarizer through an adhesive layer, and, furthermore, a dye absorbing light in a specific wavelength range is added to any configurational layer in the laminate, it is possible to suppress the decomposition of the dye by light without impairing wide color reproduction ranges. The present invention has been completed by further repeating studies on the basis of the above-described finding.

That is, the above-described object is achieved by the following configurations.

<1> A polarizing plate comprising: a polarizing plate protective film having a thickness of 20 μm or more disposed on both sides or either side of a polarizer through an adhesive layer, in which at least one of the polarizer, the polarizing plate protective film, or the adhesive layer contains one or more dyes having a main absorption wavelength range of 480 to 510 nm or 580 to 610 nm.

<2> The polarizing plate according to <1>, in which the dye is a squarine-based pigment represented by General Formula (1)

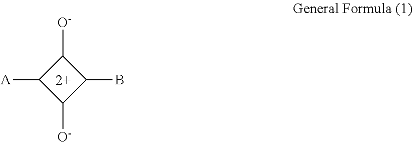

in General Formula (1), A and B each independently represent an aryl group that may have a substituent, a heterocyclic group that may have a substituent, or —CH═G, and G represents a heterocyclic group that may have a substituent.

<3> The polarizing plate according to <1> or <2>, in which the dye is contained in the polarizing plate protective film.

<4> The polarizing plate according to <3>, in which the polarizing plate protective film contains a cellulose acylate polymer.

<5> The polarizing plate according to <3>, in which the polarizing plate protective film contains a cycloolefin-based polymer.

<6> The polarizing plate according to <4> or <5>, in which a content of the dye is 0.001% by mass or more and 1% by mass or less of the cellulose acylate polymer or the cycloolefin-based polymer.

<7> A liquid crystal display device comprising: the polarizing plate according to any one of <1> to <6> disposed downstream in a light emitting direction of light that is emitted from a backlight unit.

The present invention is capable of providing a liquid crystal display device in which color reproduction ranges are wide and image quality does not easily deteriorate even in a case where the liquid crystal display device is lighted for a long period of time and a polarizing plate that is used in the liquid crystal display device.

The above-described and other characteristics and advantages of the present invention will be further clarified from the following description with reference to appropriately accompanying drawings.

### BRIEF DESCRIPTION OF THE DRAWINGS

FIG. 1 is a cross-sectional view showing a preferred embodiment of a polarizing plate of the present invention.

FIG. 2 is a cross-sectional view showing another preferred embodiment of the polarizing plate of the present invention.

FIG. 3 is a pattern diagram showing a scheme of an embodiment of a liquid crystal display device of the present invention.

FIG. 4 is an enlarged partial pattern diagram showing an example of a production method (co-casting) of a polarizing plate protective film that the polarizing plate of the present invention comprises.

### DESCRIPTION OF THE PREFERRED EMBODIMENTS

In the present invention, numerical ranges expressed using “to” include numerical values before and after “to” as the lower limit value and the upper limit value.

In the present invention, in a case where there is a plurality of substituents, linking groups, or the like (hereinafter, referred to as substituents or the like) represented by a specific reference or a plurality of substituents or the like is simultaneously or selectively regulated, it means that the respective substituents or the like may be identical to or different from one another. This is also true in the case of regulating the number of substituents or the like. In addition, in a case where a plurality of substituents or the like is close (particularly, adjacent) to one another, it means that the substituents or the like may be coupled or condensed together to form a ring.

In the present invention, an expression “compound” is used to indicate not only the compound but also salts thereof and ions thereof. In addition, the expression also indicates compounds having a structure that is partially changed to an extent in which the intended effect is not impaired. Meanwhile, examples of the salts of the compound include salts and the like formed of the compound and an inorganic acid or an organic acid. In addition, examples of the ions of the compound include ions that are generated by the dissolution of the compound in water, a solvent, or the like.

In the present invention, a term “(meth)acrylic” is used to indicate both “methacrylic” and “acrylic”.

In the present specification, substituents (also true for linking groups) that are not clearly specified as being substituted or unsubstituted mean that the substituents may have a random substituent as long as a desired effect is not impaired. This is also true for compounds or repeating units that are not clearly specified as being substituted or unsubstituted.

In the present invention, in the case of regulating the number of carbon atoms in a certain group, the number of carbon atoms refers to the number of carbon atoms in the entire group. That is, in a case where the group further has a substituent, the number of carbon atoms indicates the number of carbon atoms included not only in the group but also in the substituent.

In the present invention, in a case where a certain group is capable of forming a noncyclic skeleton and a cyclic skeleton, unless particularly otherwise described, the group indicates both a group having a noncyclic skeleton and a group having a cyclic skeleton. For example, unless particularly otherwise described, the scope of alkyl groups includes linear alkyl groups, branched alkyl groups, and cyclic (cyclo) alkyl groups. In a case where a certain group forms a cyclic skeleton, the lower limit of carbon atoms in the group having a cyclic skeleton is preferably 3 or more and more preferably 5 or more regardless of the lower limit of carbon atoms that is specifically described for the group.

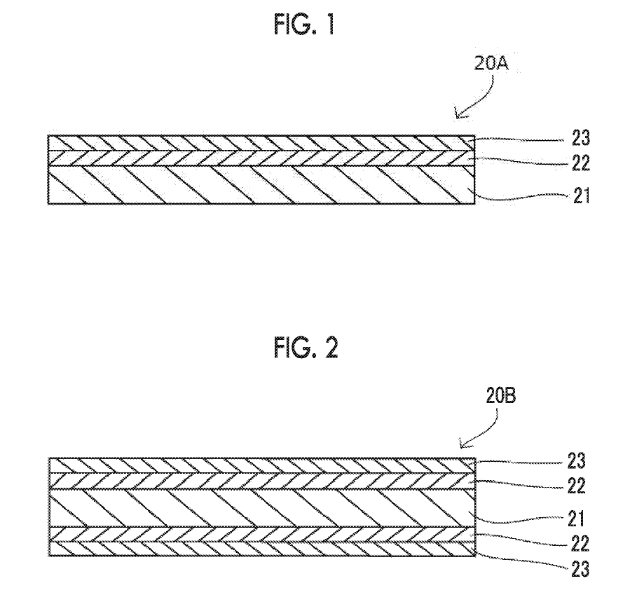

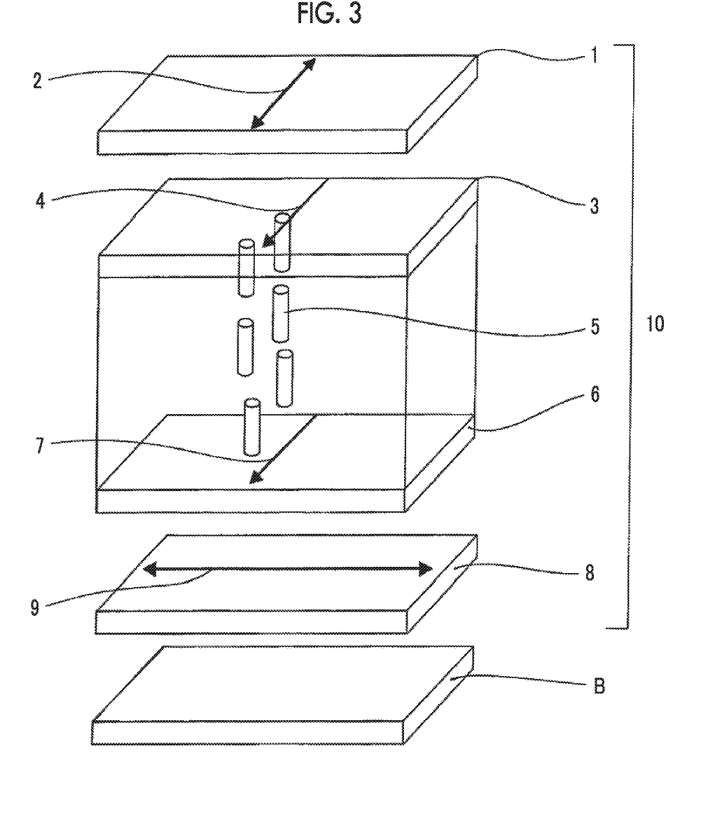

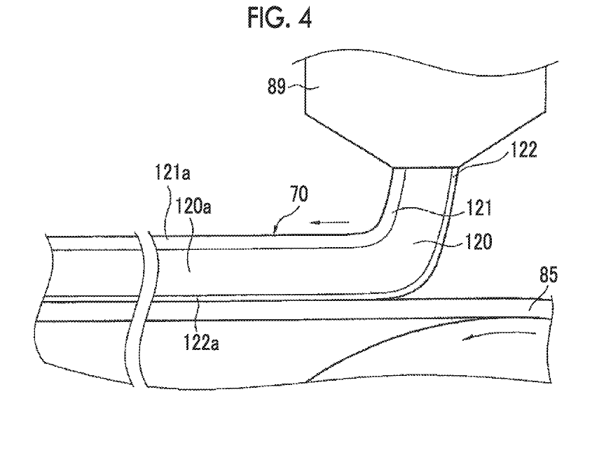

FIG. 1 to FIG. 4 are pattern diagrams for facilitating the understanding of the present invention, and, in all of polarizing plates shown in FIG. 1 and FIG. 2 and a liquid crystal display device shown in FIG. 3, the sizes, relative dimensional relationships, and the like of individual members are changed in some cases for the convenience of description and do not necessarily indicate actual relationships. This is also true for a production method of a polarizing plate protective film shown in FIG. 4.

[Polarizing Plate]

First, regarding a polarizing plate of the present invention, a layer structure thereof will be described.

The polarizing plate of the present invention has a polarizer and a polarizing plate protective film having a specific thickness on a surface of the polarizer through an adhesive layer. The polarizing plate protective film having a specific thickness (and the adhesive layer) may be provided on at least one surface of the polarizer or may be provided on both surfaces. In a case where the polarizing plate protective film having a specific thickness is provided on one surface of the polarizer, a well-known polarizing plate protective film may be provided on a surface of the polarizer opposite to the surface on which the polarizing plate protective film having a specific thickness is provided.

In the present invention, the polarizing plate protective film being provided on the surface of the polarizer through the adhesive layer means that the adhesive layer and the polarizing plate protective film are laminated in this order on the surface of the polarizer in the configuration, and other layers may or may not be provided between the polarizer and the adhesive layer and/or between the adhesive layer and the polarizing plate protective film. In the present invention, the polarizing plate preferably has a configuration in which the polarizer, the adhesive layer, and the polarizing plate protective film are directly laminated (superimposed) (a configuration in which other layers are not interposed).

In a case where the polarizing plate of the present invention has the above-described configuration, other configurations are not limited as long as the effect of the present invention is not impaired.

For example, each of the polarizer, the adhesive layer, and the polarizing plate protective film may be a single layer or a multilayer. In a case where each of the polarizer, the adhesive layer, and the polarizing plate protective film is a multilayer, the dye may be contained in any layer of the multilayer. In addition, a variety of functional layers specialized in a specific function may be provided on the surface of the polarizing plate protective film. Such functional layers will be described below.

A polarizing plate 20A as a preferred embodiment of the present invention, as shown in FIG. 1, has a polarizer 21, an adhesive layer 22 directly provided on one surface of the polarizer 21, and a polarizing plate protective film 23 directly provided on a surface of the adhesive layer 22. The thickness of the polarizing plate protective film 23 is set to 20 μm or more.

A polarizing plate 20B as a preferred embodiment of the present invention, as shown in FIG. 2, has the polarizer 21, the adhesive layers 22 directly provided on both surfaces of the polarizer 21 respectively, and the polarizing plate protective films 23 directly provided on the surfaces of the adhesive layers 22 respectively. The thickness of at least one of the two polarizing plate protective films 23 is set to 20 μm or more, and the thicknesses of both polarizing plate protective films may be set to 20 μm or more. In the polarizing plate 20B, the two adhesive layers 22 and the two polarizing plate protective films 23 may be identical to or different from each other respectively. For example, any one of the polarizing plate protective films may contain a dye described below, and the other polarizing plate protective film may not contain the dye while the thicknesses of both polarizing plate protective films 23 are set to 20 μm or more.

In FIG. 1 and FIG. 2, the polarizing plate protective films 23 are both shown as films having a single-layer structure; however, as described above, the polarizing plate protective films may be films having a multilayer structure. For example, it is possible to provide a three-layer structure to the polarizing plate protective film 23.

The polarizing plate of the present invention comprises the above-described layer configuration regarding the polarizer, the adhesive layer, and the polarizing plate protective film and, furthermore, contains a specific dye described below in at least one of the polarizer, the polarizing plate protective film, or the adhesive layer. The polarizing plate preferably contains the dye in any one or both of the polarizing plate protective film and the adhesive layer and more preferably contains the dye in the polarizing plate protective film since it is possible to effectively suppress the decomposition of the dye by light.

The content of the dye is not limited in any of the polarizer, the polarizing plate protective film, and the adhesive layer as long as the effect of the present invention is not impaired and can be appropriately set. In the present invention, the content of the dye is preferably 0.001% to 1% by mass of a matrix (generally, a polymer, but not limited thereto) configuring the polarizer, the polarizing plate protective film, or the adhesive layer. In a case where the polarizing plate comprises the above-described layer configuration and, furthermore, the content of the dye in a configurational layer is as small as 1% by mass, it is possible to effectively suppress the decomposition of the dye by light. The content of the dye is more preferably 0.005% to 0.05% by mass since it is possible to more effectively suppress the decomposition of the dye.

In the polarizing plate of the present invention, the content of the dye needs to satisfy the above-described range, and, in each layer containing the dye among the polarizer, the polarizing plate protective film, and the adhesive layer, the content of the dye per square meter of the layer is preferably 0.001 to 1.0 g/m², more preferably 0.01 to 0.7 g/m², and still more preferably 0.01 to 0.05 g/m².

In a case where the polarizing plate contains two or more dyes having a main absorption wavelength range in a specific wavelength range described below, the above-described content refers to the total content of the dyes.

The reason for the polarizing plate or a liquid crystal display device of the present invention having wide color reproduction ranges and image quality that does not easily deteriorate even in a case where the liquid crystal display device is lighted for a long period of time is not clear, but is considered as follows.

That is, in a case where the specific dye described below is added to any of the layers or the film configuring the polarizing plate, the polarizing plate absorbs unnecessary light (light of wavelength in wavelength ranges other than RGB described below) included in incident light from a backlight unit, and it is possible to selectively transmit desired light of wavelength. Furthermore, in a case where, particularly, the pigment is present in a low concentration even after being exposed to light incident from the backlight unit or a viewer's side, the influence of a chain reaction (decomposition) by an active species (an organic radical, active oxygen, or the like) that is generated by the photolysis of the pigment is small, and the decomposition of the dye can be suppressed. The above-described optical filter function and dye decomposition-suppressing function cooperate with each other without offsetting each other, and thus the polarizing plate of the present invention and liquid crystal display devices comprising the polarizing plate exhibit excellent characteristics of wide color reproduction ranges and image quality that does not easily deteriorate even in a case where the liquid crystal display device is lighted for a long period of time (highly resistant to light).

Next, the dye (pigment) that the polarizing plate of the present invention contains will be described.

The dye that the polarizing plate of the present invention contains is any one or both of a dye having a main absorption wavelength range in a wavelength range of 480 to 510 nm (hereinafter, referred to as the dye A) and a dye having a main absorption wavelength range in a wavelength range of 580 to 610 nm (hereinafter, referred to as the dye B).

The detail will be described below, and the polarizing plate of the present invention is also capable of containing dyes other than the dye A and the dye B.

The dye A is not particularly limited as long as the dye has a main absorption wavelength range in a wavelength range of 480 to 510 nm, and a variety of dyes can be used. As the dye A, there are a lot of dyes that exhibit fluorescent light.

In the present invention, an expression “having a main absorption wavelength range in a wavelength range of XX to YY nm” means that, in the visible light absorption spectrum (a wavelength range of 380 to 750 nm), a wavelength at which the wavelength of maximum absorption appears is present in a wavelength range of XX to YY nm. Therefore, in a case in which this wavelength is present in the above-described wavelength range, the entire absorption range including this wavelength may be in the above-described wavelength range or may also extend up to the outside of the above-described wavelength range. In addition, in a case where there is a plurality of wavelengths of maximum absorption, a wavelength of maximum absorption at which absorbance that is not highest appears may be present outside the wavelength range of XX to YY nm. Meanwhile, in a case where there is a plurality of wavelengths at which the wavelength of maximum absorption appears, one of the wavelengths may be present in the above-described wavelength range.

Specific examples of the dye A include, for example, individual dyes such as methine-based dyes such as pyrrole methine (PM)-based dyes, rhodamine (RH)-based dyes, boron dipyrromethene (BODIPY)-based dyes, squarine (SQ)-based dyes, and merocyanine.

For example, it is also possible to preferably use a commercially available product such as FDB-007 (trade name, merocyanine-based dye, manufactured by Yamada Chemical Co., Ltd.) as the dye A.

The dye B is not particularly limited as long as the dye has a main absorption wavelength range in a wavelength range of 580 to 610 nm, and a variety of dyes can be used. As the dye B, there are a lot of dyes that exhibit weaker fluorescent light than the dye A or exhibit no tendencies.

Specific examples of the dye B include, for example, individual dyes such as tetraaza porphyrin (TAP)-based dyes and cyanine (CY)-based dyes. In addition, it is also possible to preferably use a commercially available product such as PD-311S (trade name, tetraaza porphyrin-based dye, manufactured by Yamada Chemical Co., Ltd.) and FDG-006 (trade name, tetraaza porphyrin-based dye, manufactured by Yamada Chemical Co., Ltd.) as the dye B.

Among these, the dye A and the dye B are preferably squarine-based pigments and more preferably squarine-based pigments represented by General Formula (1).

In the present invention, in pigments represented by individual general formulae below, a cation is present in a delocalized manner, and a plurality of tautomer structures is present. Therefore, in the present invention, in a case where at least one tautomer structure of a certain pigment matches the individual general formulae, the certain pigment is considered as the pigments represented by the individual general formulae. Therefore, a pigment represented by a specific general formula can also be said to be a pigment having at least one tautomer structure that can be represented by the specific general formula. In the present invention, a pigment represented by a general formula may have any tautomer structure as long as at least one tautomer structure of the dye matches the general formula.

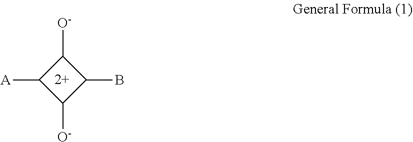

In General Formula (1), A and B each independently represent an aryl group that may have a substituent, a heterocyclic group that may have a substituent, or —CH═G. G represents a heterocyclic group that may have a substituent.

An aryl group that can be employed as A or B is not particularly limited and may be a group formed of a single ring or a group formed of a fused ring. The number of carbon atoms in the aryl group is preferably 6 to 30, more preferably 6 to 20, and still more preferably 6 to 12. Examples of the aryl group include individual groups formed of a benzene ring or a naphthalene ring, and groups formed of a benzene ring are more preferred.

A heterocyclic group that can be employed as A or B is not particularly limited, examples thereof include groups formed of an aliphatic heterocycle or an aromatic heterocycle, and groups formed of an aromatic heterocycle are preferred. Examples of a heteroaryl group that is an aromatic heterocyclic group include heteroaryl groups that can be employed as a substituent X described below. The aromatic heterocyclic group that can be employed as A or B is preferably a group of a five-membered ring or a six-membered ring and more preferably a group of a nitrogen-containing five-membered ring. Specific examples thereof preferably include a pyrrole ring, a furan ring, a thiophene ring, an imidazole ring, a pyrazole ring, a thiazole ring, an oxazole ring, a triazole ring, an indole ring, an indolenine ring, an indoline ring, a pyridine ring, a pyrimidine ring, a quinoline ring, a benzothiazole ring, a benzooxazole ring, a pyrazolotriazole ring, and the like. Among these, groups formed of a pyrrole ring, a pyrazole ring, a thiazole ring, a pyridine ring, a pyrimidine ring, or a pyrazolotriazine ring are preferred. The pyrazolotriazine ring needs to be formed of a fused ring of a pyrazole ring and a triazole ring and be a fused ring obtained by fusing at least one pyrazole ring and at least one triazole ring. Examples thereof include fused rings in General Formulae (4) and (5) described below.

G in —CH═G that can be employed as A or B represents a heterocyclic group that may have a substituent, and examples thereof preferably include examples listed as A and B. Among them, groups formed of a benzooxazole ring, a benzothiazole ring, or an indoline ring and the like are preferred.

Each of A, B, and G may have the substituent X, and, in a case where A, B, or G has the substituent X, adjacent substituents may bond together to further form a ring structure. In addition, a plurality of substituents may be present.

Examples of the substituent X include substituents that can be employed as R¹ in General Formula (2) described below, and specific examples thereof include a halogen atom, a cyano group, a nitro group, an alkyl group, an alkenyl group, an alkynyl group, an aryl group, a heteroaryl group, an aralkyl group, —OR^{20A}OR¹¹, —COOR¹², —OCOR¹³, —NR¹⁴R¹⁵, —NHCOR¹⁶, —CONR¹⁷R¹⁸, —NHCONR¹⁹R²⁰, —NHCOOR²¹, —SR²², —SO₂R²³, —SO₃R²⁴, —NHSO₂R²⁵, SO₂NR²⁶R²⁷, and —OR²⁸.

R¹⁰ to R²⁸ each independently represent a hydrogen atom, an aliphatic group, an aromatic group, or a heterocyclic group. An aliphatic group and an aromatic group that can be employed as R¹⁰ to R²⁸ are not particularly limited and can be appropriately selected from the substituents that can be employed as R¹ in General Formula (2) described below. A heterocyclic group that can be employed as R¹⁰ to R²⁸ may be an aliphatic group or an aromatic group and can be appropriately selected from heteroaryl groups or heterocyclic groups that can be employed as R¹ in General Formula (2) described below.

Meanwhile, in a case where R¹² in —COOR¹² is a hydrogen atom (that is, a carboxyl group), the hydrogen atom may be dissociated (that is, a carbonate group) or may be in a salt state. In addition, in a case where R²⁴ in —SO₃R²⁴ is a hydrogen atom (that is, a sulfo group), the hydrogen atom may be dissociated (that is, a sulfonate group) or may be in a salt state.

As the halogen atom, a fluorine atom, a chlorine atom, a bromine atom, and an iodine atom are exemplified.

The number of carbon atoms in the alkyl group is preferably 1 to 20, more preferably 1 to 15, and still more preferably 1 to 8. The number of carbon atoms in the alkenyl group is preferably 2 to 20, more preferably 2 to 12, and still more preferably 2 to 8. The number of carbon atoms in the alkynyl group is preferably 2 to 40, more preferably 2 to 30, and still more preferably 2 to 25. The alkyl group, the alkenyl group, and the alkynyl group each may be any of linear, branched, or cyclic and are preferably linear or branched.

The aryl group includes a group of a single ring or a fused ring. The number of carbon atoms in the aryl group is preferably 6 to 30, more preferably 6 to 20, and still more preferably 6 to 12.

An alkyl portion in the aralkyl group is identical to that in the alkyl group. An aryl portion in the aralkyl group is identical to that in the aryl group. The number of carbon atoms in the aralkyl group is preferably 7 to 40, more preferably 7 to 30, and still more preferably 7 to 25.

The heteroaryl group includes a group formed of a single ring or a fused ring, and a group formed of a single ring or a fused ring having two to eight rings is preferred, and a group formed of a single ring or a fused ring having two to four rings is more preferred. The number of hetero atoms configuring the ring in the heteroaryl group is preferably one to three. Examples of the hetero atoms configuring the ring in the heteroaryl group include a nitrogen atom, an oxygen atom, a sulfur atom, and the like. The heteroaryl group is preferably a group formed of a five-membered ring or a six-membered ring. The number of carbon atoms configuring the ring in the heteroaryl group is preferably 3 to 30, more preferably 3 to 18, and still more preferably 3 to 12. Examples of the heteroaryl group include individual groups formed of a pyridine ring, a piperidine ring, a furan ring, a furfuran ring, a thiophene ring, a pyrrole ring, a quinolone ring, a morpholine ring, an indole ring, an imidazole ring, a pyrazole ring, a carbazole ring, a phenothiazine ring, a phenoxazine ring, an indoline ring, a thiazole ring, a pyrazine ring, a thiadiazine ring, a benzoquinoline ring, or a thiadiazole ring.

The alkyl group, the alkenyl group, the alkynyl group, the aralkyl group, the aryl group, and the heteroaryl group exemplified as the examples of the substituent X may respectively further have a substituent and may be unsubstituted. The substituent that the above-described groups may further have is not particularly limited, but is preferably a substituent selected from an alkyl group, an aryl group, an amino group, an alkoxy group, an aryloxy group, an aromatic heterocyclic oxy group, an acyl group, an alkoxycarbonyl group, an aryloxycarbonylamino group, an acyloxy group, an acylamino group, an alkoxycarbonylamino group, an aryloxycarbonylamino group, a sulfonylamino group, an alkylthio group, an arylthiol group, an aromatic heterocyclic thio group, a sulfonyl group, a hydroxy group, a mercapto group, a halogen atom, a cyano group, a sulfo group, and a carboxyl group, and more preferably a substituent selected from an alkyl group, an aryl group, an alkoxy group, an aryloxy group, an aromatic heterocyclic oxy group, an acyl group, an alkoxycarbonyl group, an aryloxycarbonyl group, an acyloxy group, an alkylthio group, an arylthiol group, an aromatic heterocyclic thio group, a sulfonyl group, a hydroxy group, a mercapto group, a halogen atom, a cyano group, a sulfo group, and a carboxyl group. These groups can be appropriately selected from the substituents that can be employed as R¹ in General Formula (2) described below.

As a preferred embodiment of the pigment represented by General Formula (1), a pigment represented by General Formula (2) is exemplified.

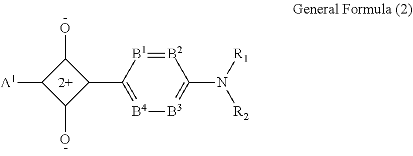

In General Formula (2), A¹ is identical to A in General Formula (1). Among them, the heterocyclic group that is a nitrogen-containing five-membered ring is preferred.

In General Formula (2), R¹ and R² each independently represent a hydrogen atom or a substituent. R¹ and R² may be identical to or different from each other, and R¹ and R² may bond together to form a ring.

Substituents that can be employed as R¹ and R² are not particularly limited, and examples thereof include alkyl groups (a methyl group, an ethyl group, a propyl group, an isopropyl group, a butyl group, a t-butyl group, an isobutyl group, a pentyl group, a hexyl group, an octyl group, a dodecyl group, a trifluoromethyl group, and the like), cycloalkyl groups (a cyclopentyl group, a cyclohexyl group, and the like), alkenyl groups (a vinyl group, an allyl group, and the like), alkynyl group (an ethynyl group, a propargyl group, and the like), aryl groups (a phenyl group, a naphthyl group, and the like), heteroaryl groups (a furyl group, a thienyl group, a pyridyl group, a pyridazyl group, a pyrimidyl group, a pyrazyl group, a triazyl group, an imidazolyl group, a pyrazolyl group, a thiazolyl group, a benzoimidazolyl group, a benzoxazolyl group, a quinazolyl group, a phthalazyl group, and the like), heterocyclic groups (also referred to as heterocyclic groups, for example, a pyrrolidyl group, an imidazolidyl group, a morpholyl group, an oxazolidyl cloud, and the like), alkoxy groups (a methoxy group, an ethoxy group, a propyloxy group, and the like), cycloalkoxy groups (a cyclopentyloxy group, a cyclohexyloxy group, and the like), aryloxy groups (a phenoxy group, a naphthyloxy group, and the like), heteroaryloxy groups (an aromatic heterocyclic oxy group), alkylthio groups (a methylthio group, an etherthio group, a propylthio group, and the like), cycloalkylthio groups (a cyclopentylthio group, a cyclohexylthio group, and the like), arylthio groups (a phenythio group, a naphthylthio group, and the like), heteroarylthio groups (an aromatic heterocyclic thio group), alkoxycarbonyl groups (a methyloxycarbonyl group, an ethyloxycarbonyl group, a butyloxycarbonyl group, an octyloxycarbonyl group, and the like), aryloxycarbonyl groups (a phenyloxycarbonyl group, a naphthyloxycarbonyl group, and the like), phosphoryl groups (a dimethoxyphosphonyl group and a diphenylphosphoryl group), sulfamoyl groups (an aminosulfonyl group, a methylaminosulfonyl group, a dimethylaminosulfonyl group, a butylaminosulfonyl group, a cyclohexylaminosulfonyl group, an octylaminosulfonyl group, a phenylaminosulfonyl group, a 2-pyridylaminosulfonyl group, and the like), acyl groups (an acetyl group, an ethylcarbonyl group, a propylcarpanyl group, a cyclohexylcarbonyl group, an octylcarbonyl group, a 2-ethylhexylcarbonyl group, a phenylcarbonyloxy group, a naphthylcarbonyl group, a pyridylcarbonyl group, and the like), acyloxy groups (an acetyloxy group, an ethylcarbonyloxy group, a butylcarbonyloxy group, an octylcarbonyloxy group, a phenylcarbonyloxy group, and the like), amide groups (a methylcarbonylamino group, an ethylcarbonylamino group, a dimethylcarbonylamino group, a propylcarbonylamino group, a pentylcarbonylamino group, a cyclohexylcarbonylamino group, a 2-ethylhexylcarbonylamino group, an octylcarbonylamino group, a dodecylcarbonylamino group, a phenylcarbonylamino group, a naphthylcarbonylamino group, and the like), sulfonylamide(sulfonamide) groups (a methylsulfonylamino group, an octylsulfonylamino group, a 2-ethylhexylsulfonylamino group, a trifluoromethylsulfonylamino group, and the like), carbamoyl groups (an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, a 2-pyridylaminocarbonyl group, and the like), ureido groups (a methylureido group, an ethylureido group, a pentylureido group, a cyclohexylureido group, an octylureido group, a dodecylureido group, a phenylureido group, a naphthylureido group, a 2-pyridylaminoureido group, and the like), alkylsulfonyl groups (a methylsulfonyl group, an ethylsulfonyl group, a butylsulfonyl group, a cyclohexylsulfonyl group, a 2-ethylhexylsulfonyl group, and the like), arylsulfonyl groups (a phenylsulfonyl group, a naphthylsulfonyl group, a 2-pyridylsulfonyl group, and the like), amino groups (an amino group, an ethylamino group, a dimethylamino group, a butylamino group, a dibutylamino group, a cyclopentylamino group, a 2-ethylhexylamino group, a dodecylamino group, an anilino group, a naphthylamino group, a 2-pyridylamino group, and the like), alkylsulfonyloxy groups (methanesulfonyloxy), a cyano group, a nitro group, halogen atoms (a fluorine atom, a chlorine atom, a bromine atom, and the like), a hydroxy group, and the like.

Among these, an alkyl group, an alkenyl group, an aryl group, or a heteroaryl group is preferred, an alkyl group, an aryl group, or a heteroaryl group is more preferred, and an alkyl group is still more preferred.

A substituent that can be employed as R¹ and R² may further have a substituent. As the substituent that the substituent that can be employed as R¹ and R² may further have, the above-described substituents that can be employed as R¹ and R² are exemplified. In addition, R¹ and R² may bond together or bond with a substituent that B² or B³ has to form a ring. As the ring that is formed at this time, a heterocycle or a heteroaryl ring is preferred, and the size of the ring being formed is not particularly limited, but a five-membered ring or a six-membered ring is preferred.

In General Formula (2), B¹, B², B³, and B⁴ each independently represent a carbon atom or a nitrogen atom. The ring including B¹, B², B³, and B⁴ is an aromatic ring. At least two or more of B¹ to B⁴ are preferably carbon atoms, and all of B¹ to B⁴ are more preferably carbon atoms.

A carbon atom that can be employed as B¹ to B⁴ has a hydrogen atom or a substituent. Among carbon atoms that can be employed as B¹ to B⁴, the number of carbon atoms having a substituent is not particularly limited, but is preferably zero, one, or two and more preferably one. Particularly, it is preferable that B¹ and B⁴ are carbon atoms and at least one has a substituent.

The substituent that the carbon atom that can be employed as B¹ to B⁴ has is not particularly limited, and examples thereof include the above-described substituents that can be employed as R¹ and R². Among them, an alkyl group, an alkoxy group, an alkoxycarbonyl group, an aryl group, an acyl group, an amide group, a sulfonamide group, a carbamoyl group, an alkylsulfonyl group, an arylsulfonyl group, an amino group, a cyano group, a nitro group, a halogen atom, or a hydroxy group is preferred, and an alkyl group, an alkoxy group, an alkoxycarbonyl group, an aryl group, an acyl group, an amide group, a sulfonamide group, a carbamoyl group, an amino group, a cyano group, a nitro group, a halogen atom, or a hydroxy group is more preferred.

As the substituent that the carbon atom that can be employed as B¹ and B⁴ has, an alkyl group, an alkoxy group, a hydroxy group, an amide group, a sulfonamide group, or a carbamoyl group is still more preferred, an alkyl group, an alkoxy group, a hydroxy group, an amide group, or a sulfonamide group is particularly preferred, and a hydroxy group, an amide group, or a sulfonamide group is most preferred.

As the substituent that the carbon atom that can be employed as B² and B³ has, an alkyl group, an alkoxy group, an alkoxycarbonyl group, an acyl group, an amino group, a cyano group, a nitro group, or a halogen atom is still more preferred, and it is particularly preferable that the substituent in any one of B² and B³ is an electron-withdrawing group (for example, an alkoxycarbonyl group, an acyl group, a cyano group, a nitro group, or a halogen atom).

The pigment represented by General Formula (2) is preferably a pigment represented by any of General Formula (3), General Formula (4), and General Formula (5).

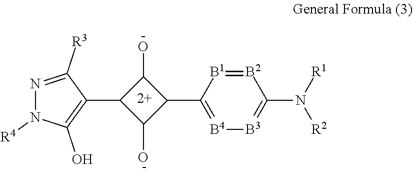

In General Formula (3), R¹ and R² each independently represent a hydrogen atom or a substituent and are identical to R¹ and R² in General Formula (2), and the preferred ranges are also identical.

B¹ to B⁴ each independently represent a carbon atom or a nitrogen atom and are identical to B¹ to B⁴ in General Formula (2), and the preferred ranges are also identical.

In General Formula (3), R³ and R⁴ each independently represent a hydrogen atom or a substituent. A substituent that can be employed as R³ and R⁴ is not particularly limited, and the same substituents as the substituents that can be employed as R¹ and R² can be exemplified.

However, the substituent that can be employed as R³ is preferably an alkyl group, an alkoxy group, an amino group, an amide group, a sulfonamide group, a cyano group, a nitro group, an aryl group, a heteroaryl group, a heterocyclic group, an alkoxycarbonyl group, a carbamoyl group, or a halogen atom, more preferably an alkyl group, an aryl group, or an amino group, and still more preferably an alkyl group.

The substituent that can be employed as R⁴ is preferably an alkyl group, an aryl group, a heteroaryl group, a heterocyclic group, an alkoxy group, an alkoxycarbonyl group, an acyl group, an acyloxy group, an amide group, a carbamoyl group, an amino group, or a cyano group, more preferably an alkyl group, an alkoxycarbonyl group, an acyl group, a carbamoyl group, or an aryl group, and still more preferably an alkyl group.

An alkyl group that can be employed as R³ and R⁴ may be any of linear, branched, or cyclic and is preferably linear or branched. The number of carbon atoms in the alkyl group is preferably 1 to 12 and more preferably 1 to 8. As examples of the alkyl group, a methyl group, an ethyl group, an n-propyl group, an isopropyl group, a t-butyl group, a 2-ethylhexyl group, and a cyclohexyl group are preferred, and a methyl group ad a t-butyl group are more preferred.

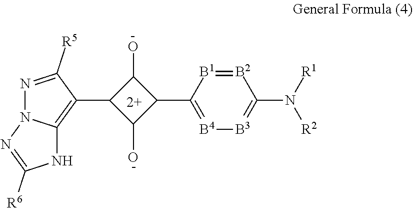

In General Formula (4), R¹ and R² each independently represent a hydrogen atom or a substituent and are identical to R¹ and R² in General Formula (2), and the preferred ranges are also identical.

B¹ to B⁴ each independently represent a carbon atom or a nitrogen atom and are identical to B¹ to B⁴ in General Formula (2), and the preferred ranges are also identical.

In General Formula (4), R⁵ and R⁶ each independently represent a hydrogen atom or a substituent. A substituent that can be employed as R⁵ and R⁶ is not particularly limited, and the same substituents as the substituents that can be employed as R¹ and R² can be exemplified.

However, the substituent that can be employed as R⁵ is preferably an alkyl group, an alkoxy group, an aryloxy group, an amino group, a cyano group, an aryl group, a heteroaryl group, a heterocyclic group, an acyl group, an acyloxy group, an amide group (an acylamino group), a sulfonamide group, an ureido group, or a carbamoyl group, more preferably an alkyl group, an alkoxy group, an acyl group, an amide group, or an amino group, and still more preferably an alkyl group.

An alkyl group that can be employed as R⁵ is identical to the alkyl group that can be employed as R³, and the preferred range is also identical.

The substituent that can be employed as R⁶ is preferably an alkyl group, a cycloalkyl group, an alkenyl group, an aryl group, a heteroaryl group, a heterocyclic group, an alkoxy group, a cycloalkoxy group, an aryloxy group, an alkoxycarbonyl group, an acyl group, an acyloxy group, an amide group, a sulfonamide group, an alkylsulfonyl group, an arylsulfonyl group, a carbamoyl group, an amino group, a cyano group, a nitro group, or a halogen atom, more preferably an alkyl group, an aryl group, a heteroaryl group, or a heterocyclic group, and still more preferably an alkyl group or an aryl group.

An alkyl group that can be employed as R⁶ is identical to the alkyl group that can be employed as R⁴, and the preferred range is also identical.

An aryl group that can be employed as R⁶ is preferably an aryl group having 6 to 12 carbon atoms and more preferably a phenyl group. This aryl group may have a substituent, as such a substituent, groups selected from the following substituent group A are exemplified, and, particularly, an alkyl group, a sulfonyl group, an amino group, an acylamino group, a sulfonylamino group, and the like which have 1 to 10 carbon atoms are preferred. These substituents may further have a substituent. Specifically, the substituent is preferably an alkylsulfonylamino group.

—Substituent Group A—

A halogen atom, an alkyl group, an alkenyl group, an alkynyl group, an aryl group, a heterocyclic group, a cyano group, a hydroxy group, a nitro group, a carboxyl group, an alkoxy group, an aminooxy group, an aryloxy group, a silyloxy group, a heterocyclic oxy group, an acyloxy group, a carbamoyloxy group, an amino group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heterocyclic thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heterocyclic azo group, an imide group, a phosphino group, a phosphinyl group, a phosphinyloxy group, a phosphinylamino group, a silyl group, and the like

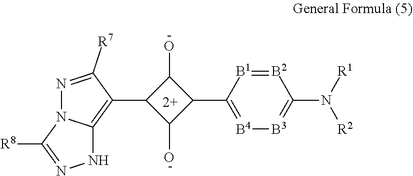

In General Formula (5), R¹ and R² each independently represent a hydrogen atom or a substituent and are identical to R¹ and R² in General Formula (2), and the preferred ranges are also identical.

B¹ to B⁴ each independently represent a carbon atom or a nitrogen atom and are identical to B¹ to B⁴ in General Formula (2), and the preferred ranges are also identical.

In General Formula (5), R⁷ and R⁸ each independently represent a hydrogen atom or a substituent. A substituent that can be employed as R⁷ and R⁸ is not particularly limited, and the same substituents as the substituents that can be employed as R¹ and R² can be exemplified.

However, a preferred range, a more preferred range, and a still more preferred group of the substituent that can be employed as R⁷ are identical to those of the substituent that can be employed as R⁵. An alkyl group that can be employed as R⁵ is identical to the alkyl group that can be employed as R³, and the preferred range is also identical.

A preferred range, a more preferred range, and a still more preferred group of the substituent that can be employed as R⁸ are identical to those of the substituent that can be employed as R⁶. Preferred ranges of an alkyl group and an aryl group that can be employed as R⁸ are identical to those of the alkyl group and the aryl group that can be employed as R⁶, and the preferred ranges are also identical.

In the present invention, in a case where a squarine-based dye is used as the dye B, the squarine-based dye is not particularly limited, and the squarine pigments represented by any of General Formulae (1) to (5) are preferably exemplified. Examples thereof include compounds described in, for example, JP2006-160618A, WO2004/005981A, WO2004/007447A, Dyes and Pigment, 2001, 49, pp. 161 to 179, WO2008/090757A, WO2005/121098A, and JP2008-275726A.

Hereinafter, specific examples of the pigments represented by any of General Formula (1) to General Formula (5) will be shown. However, the present invention is not limited thereto.

In the following specific examples, Me represents methyl, Et represents ethyl, and Ph represents phenyl respectively.

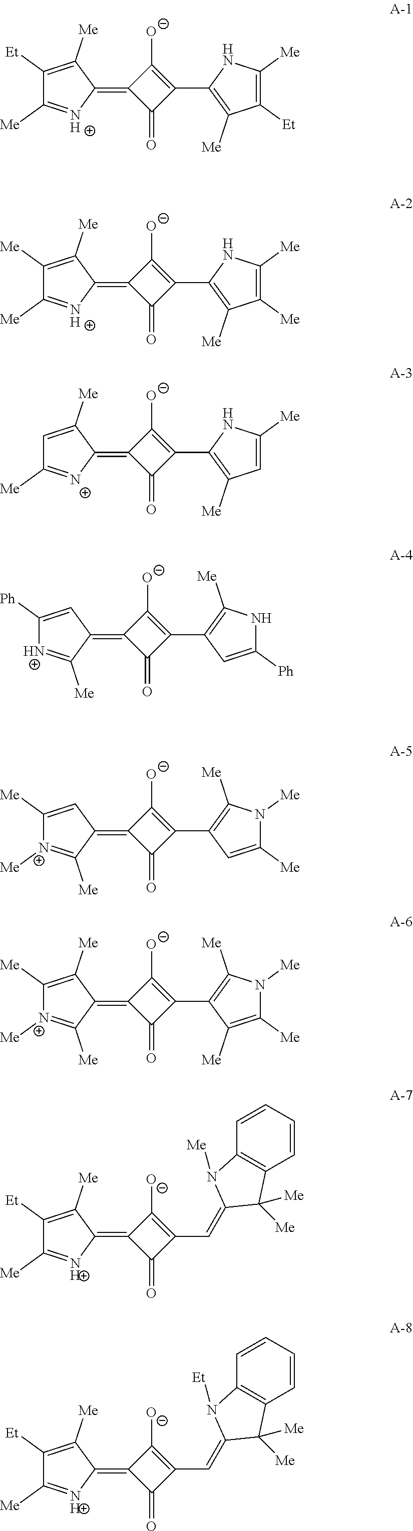

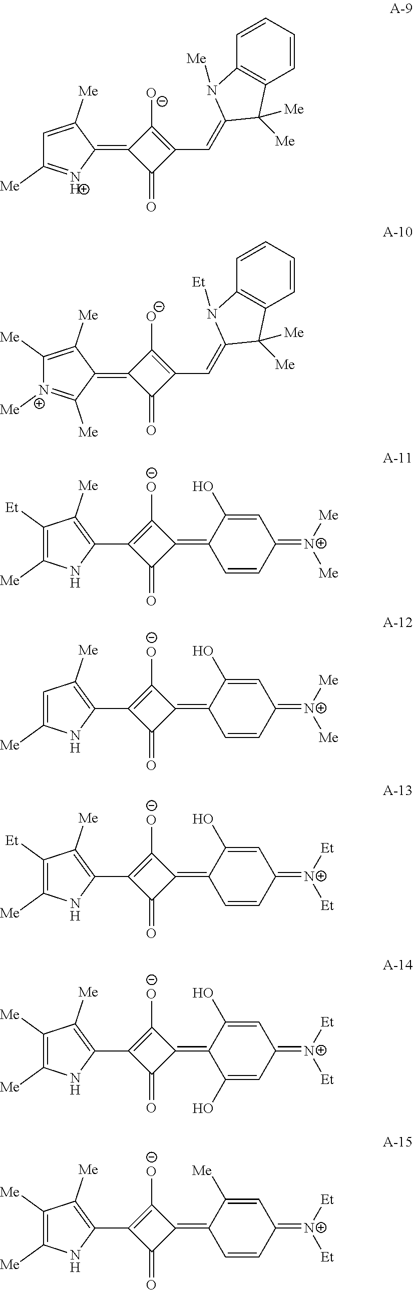

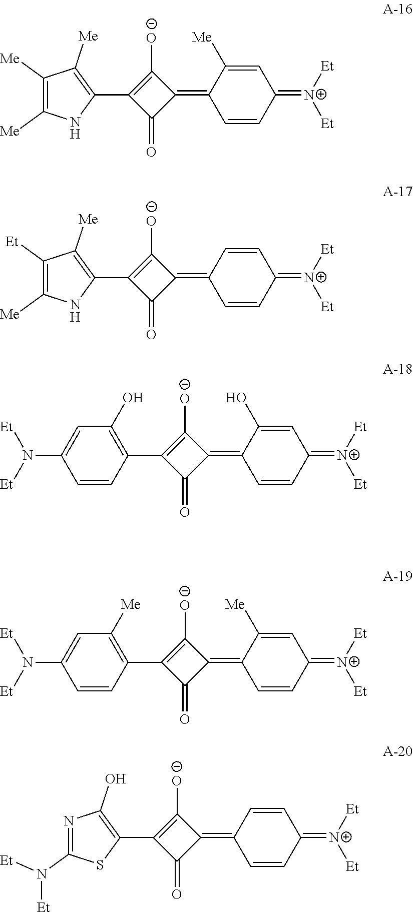 [SMILES: CC[N+](CC)=C1C=C/C(=C2\C(=O)C(c3[nH]c(C)c(C)c3C)=C2[O-])C(C)=C1 ; CCc1c(C)[nH]c(C2=C([O-])C(=C3C=CC(=[N+](CC)CC)C=C3)C2=O)c1C ; CCN(CC)c1ccc(C2=C([O-])/C(=C3/C=CC(=[N+](CC)CC)C=C3O)C2=O)c(O)c1 ; CCN(CC)c1ccc(C2=C([O-])/C(=C3/C=CC(=[N+](CC)CC)C=C3C)C2=O)c(C)c1 ; CCN(CC)c1nc(O)c(C2=C([O-])C(=C3C=CC(=[N+](CC)CC)C=C3)C2=O)s1]

In addition to the above-described specific examples, specific examples of the pigments represented by any of General Formulae (3) to (5) will be shown. Substituents B in the following tables represent the following structures. In the following structures and the following table, Me represents methyl, Et represents ethyl, i-Pr represents i-propyl, Bu represents n-butyl, t-Bu represents t-butyl, and Ph represents phenyl respectively. In the following structures, * indicates a bonding site with a four-membered carbon ring in each general formula.

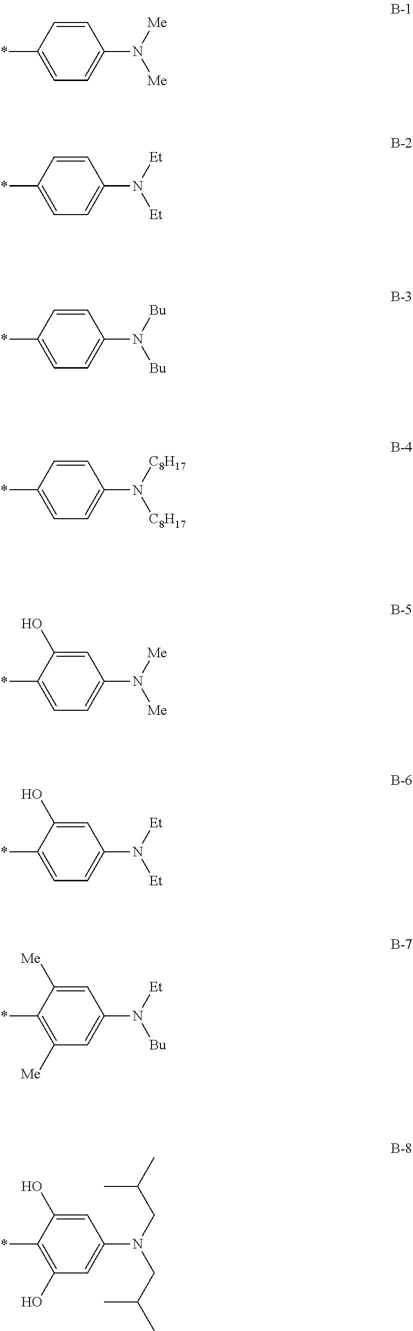

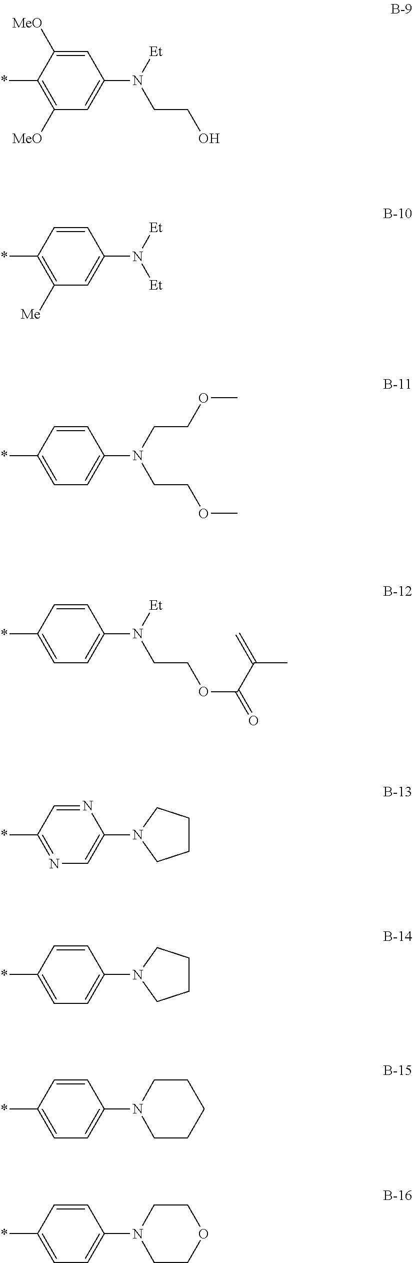

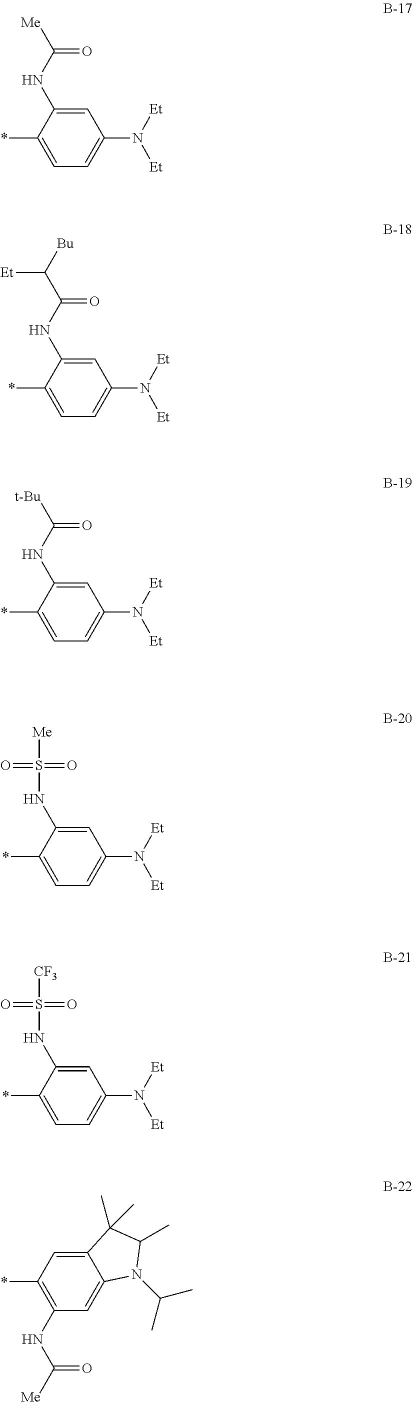

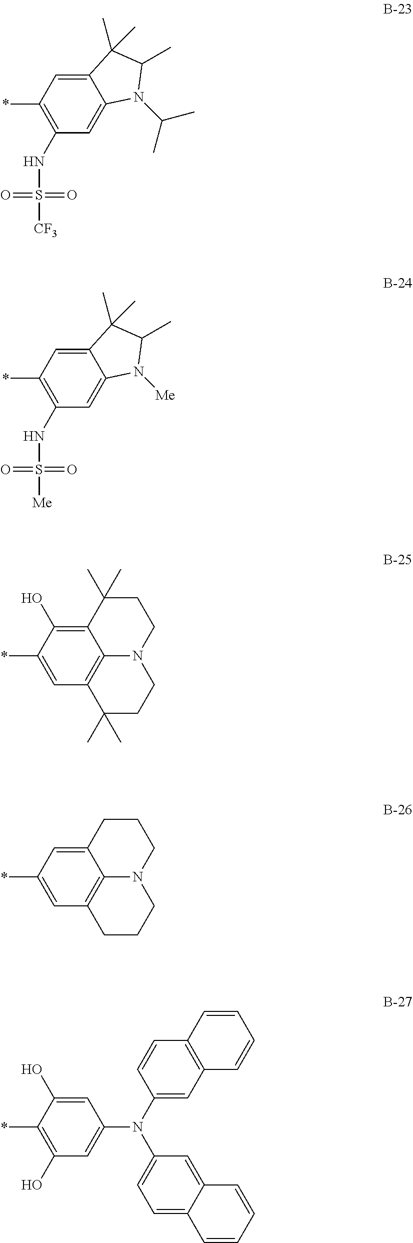

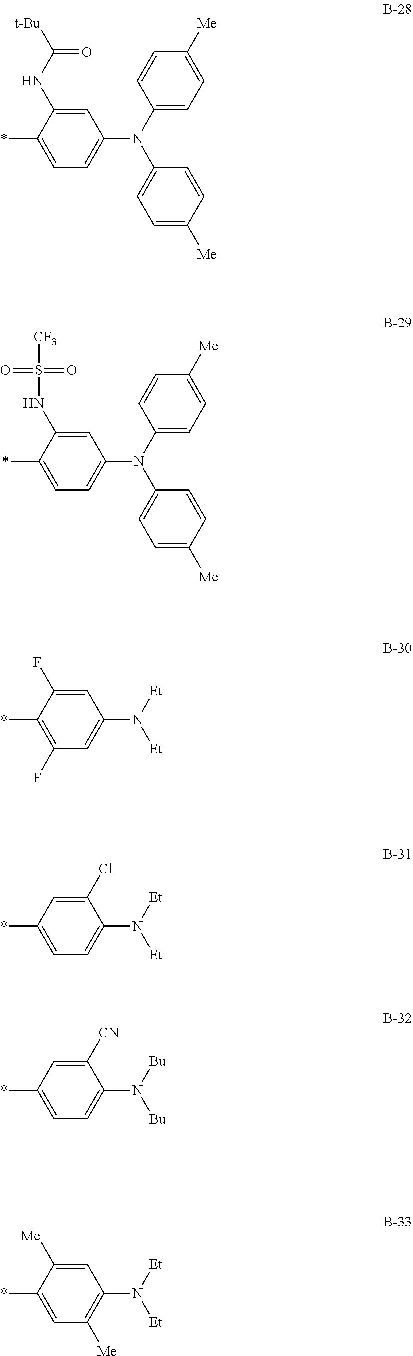

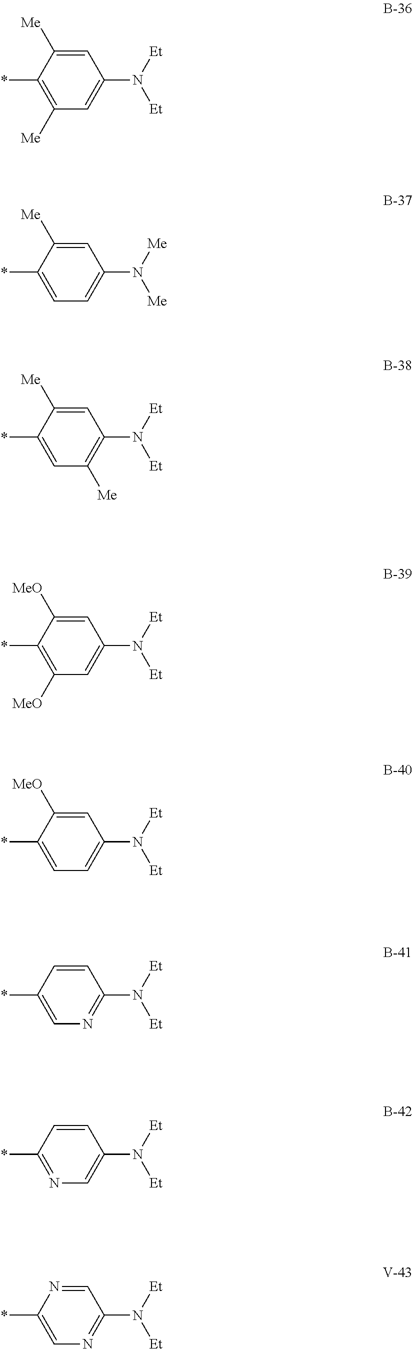

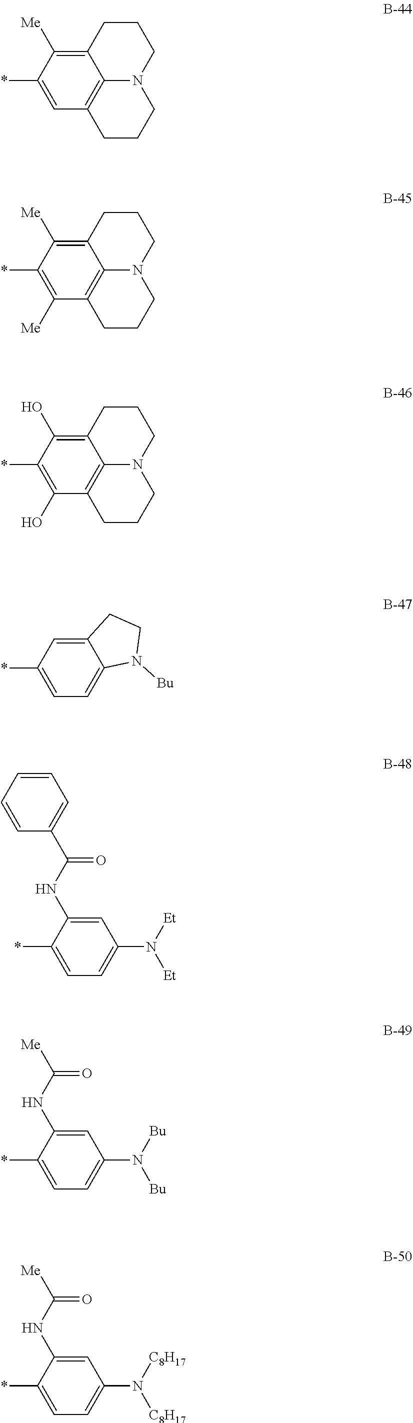

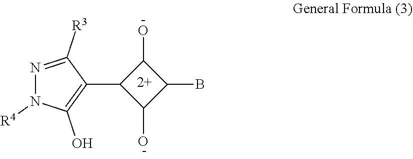

| Com- | | | |
|---|---|---|---|
| pound | | | |
| No. | R³ | R⁴ | B |
| 3-1 | Me | Me | B-3 |
| 3-2 | Me | Me | B-4 |
| 3-3 | Me | Me | B-5 |
| 3-4 | Me | Me | B-10 |
| 3-5 | Me | Me | B-14 |
| 3-6 | Me | Me | B-16 |
| 3-7 | Me | Me | B-17 |
| 3-8 | Me | Me | B-18 |
| 3-9 | Me | Me | B-19 |
| 3-10 | Me | Me | B-20 |
| 3-11 | Me | Me | B-21 |
| 3-12 | Me | Me | B-22 |
| 3-13 | Me | Me | B-23 |
| 3-14 | Me | Me | B-26 |
| 3-15 | Me | Me | B-32 |
| 3-16 | Me | Me | B-33 |
| 3-17 | Me | Me | B-38 |
| 3-18 | Me | Me | B-49 |
| 3-19 | Et | 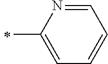 | B-28 |
| 3-20 | Me | 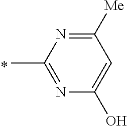 | B-29 |
| 3-21 | H | H | B-23 |
| 3-22 | Et | t-Bu | B-21 |
| 3-23 | t-Bu | Me | B-18 |
| 3-24 | CF₃ | i-Pr | B-12 |
| 3-25 | COOEt | Et | B-6 |
| 3-26 | CN | Ph | B-11 |
| 3-27 | NMe₂ | Me | B-2 |
| 3-28 | i-Pr | Me | B-17 |
| 3-29 | OEt | Bu | B-27 |
| 3-30 | NH₂ | i-Pr | B-9 |
| 3-31 | t-Bu | Me | B-17 |
| 3-32 | t-Bu | Bu | B-21 |
| 3-33 | CF₃ | Me | B-18 |
| 3-34 | OEt | Et | a-33 |
| 3-35 | NMe₂ | i-Pr | B-2 |
| 3-36 | Et | Me | B-17 |
| 3-37 | Bu | Me | B-18 |
| 3-38 | NH₂ | Ph | B-19 |
| 3-39 | OEt | 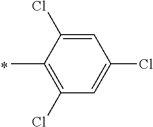 | B-25 |
| 3-40 | Me | 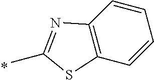 | B-2 |
| 3-41 | Me | Ph | B-17 |
| 3-42 | Me | Ph | B-21 |
| 3-43 | Me | Ph | B-36 |
| 3-44 | Me | t-Bu | B-17 |
| 3-45 | Me | t-Bu | B-18 |
| 3-46 | Me | t-Bu | B-10 |
| 3747 | PEt | Me | B-17 |
| 3-48 | OEt | Me | B-10 |
| 3-49 | Me | 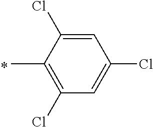 | B-17 |
| 3-50 | Me | 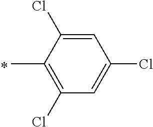 | B-19 |
| 3-51 | Me | 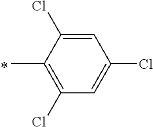 | B-21 |
| 3-52 | Me | 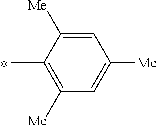 | B-17 |
| 3-53 | Me | 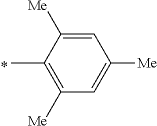 | B-20 |
| 3-54 | Me | 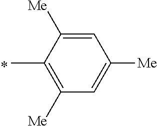 | B-21 |
| 3-55 | t-au | Me | 8-17 |
| 3-56 | t-Bu | Me | B-10 |
| 3-57 | t-Bu | Me | B-44 |
| 3-58 | t-Bu | t-Bu | B-17 |
| 3-59 | t-Bu | t-Bu | B-10 |
| 3-60 | t-Bu | t-BU | B-6 |
| 3-61 | NBu₂ | Me | B-17 |
| 3-62 | NBu₂ | Me | B-10 |
| 3-63 | t-Bu | 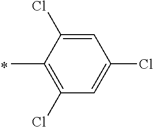 | B-17 |
| 3-64 | t-Bu | 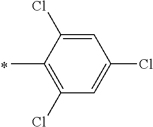 | B-19 |
| 3-65 | t-Bu | 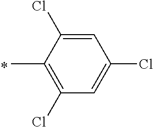 | B-21 |
| 3-66 | t-Bu | 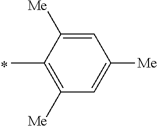 | B-17 |
| 3-67 | t-Bu | 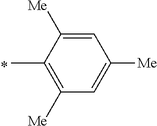 | B-20 |
| 3-68 | t-Bu | 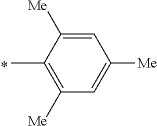 | B-21 |

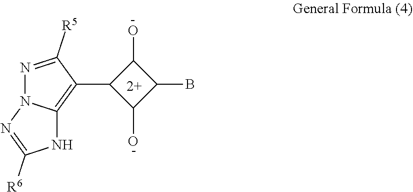

| Com- | | | |
|---|---|---|---|
| pound | | | |
| No. | R⁵ | R⁶ | B |
| 4-1 | t-Bu | 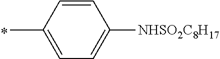 | B-2 |
| 4-2 | t-Bu | 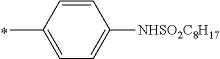 | B-6 |
| 4-3 | t-Bu | 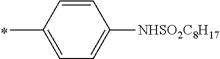 | B-10 |
| 4-4 | Me | 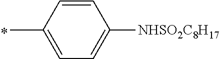 | B-4 |
| 4-5 | t-Bu | 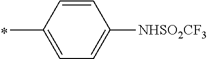 | B-6 |
| 4-6 | t-Bu | 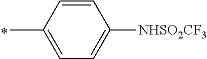 | B-14 |
| 4-7 | NHCOCH₃ | 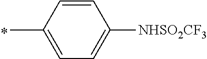 | B-1 |
| 4-8 | t-Bu | 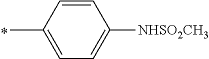 | B-6 |
| 4-9 | t-Bu | 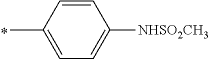 | B-16 |
| 4-10 | OEt | 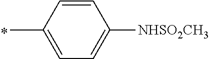 | B-11 |
| 4-11 | t-Bu | 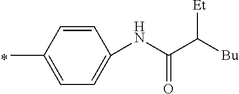 | B-6 |
| 4-12 | t-Bu | 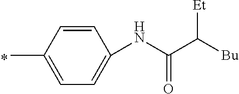 | B-12 |
| 4-13 | OEt | 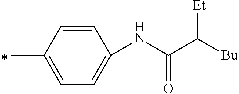 | B-31 |
| 4-14 | H | H | B-22 |
| 4-15 | Me | Me | B-23 |
| 4-16 | Me | Me | B-17 |
| 4-17 | Me | Et | B-18 |
| 4-18 | Ph | Ph | B-8 |
| 4-19 | Et | t-Bu | B-17 |
| 4-20 | OEt | t-Bu | B-3 |
| 4-21 | OEt | Bu | B-26 |
| 4-22 | OEt | 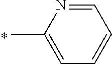 | B-2 |
| 4-23 | CF3 | t-Bu | B-19 |
| 4-24 | NHCOCH₃ | t-Bu | B-2 |
| 4-25 | NHCOCH₃ | Me | B-1 |
| 4-26 | NMe₂ | t-Bu | B-6 |
| 4-27 | NMe₂ | Et | B-17 |
| 4-28 | H | Me | B-2 |
| 4-29 | t-Bu | t-Bu | B-18 |
| 4-30 | t-Bu | Me | B-17 |

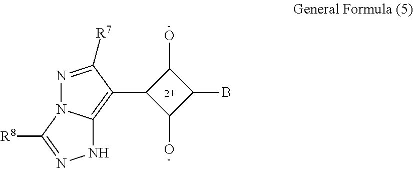

| Compound | | | |
|---|---|---|---|
| No. | R⁷ | R⁸ | B |
| 5-1 | t-Bu | 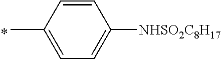 | B-2 |
| 5-2 | Me | 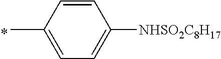 | B-6 |
| 5-3 | t-Bu | 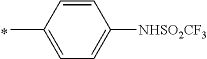 | B-4 |
| 5-4 | Me | 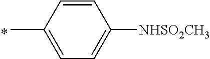 | B-10 |
| 5-5 | t-Bu | 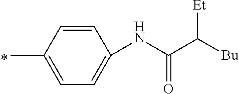 | B-6 |
| 5-6 | t-Bu | 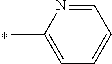 | B-14 |
| 5-7 | Me | 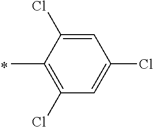 | B-1 |
| 5-8 | Me | 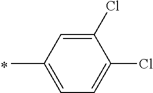 | B-6 |
| 5-9 | Me | 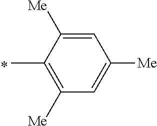 | B-16 |
| 5-10 | t-Bu | 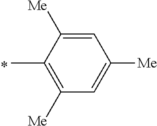 | B-11 |
| 5-11 | Me | Me | B-17 |
| 5-12 | Me | t-Bu | B-18 |
| 5-13 | Ph | Ph | B-8 |
| 5-14 | Ph | 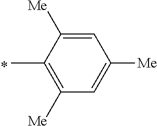 | B-17 |
| 5-15 | Et | Ph | B-17 |
| 5-16 | OEt | t-Bu | B-3 |
| 5-17 | OEt | Bu | B-26 |
| 5-18 | CF3 | t-Bu | B-19 |
| 5-19 | NHCOCH₃ | t-Bu | B-2 |
| 5-20 | NHCOCH₃ | 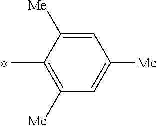 | B-1 |
| 5-21 | t-Bu | 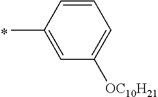 | B-2 |

As a preferred embodiment of the pigment represented by General Formula (1), a pigment represented by General Formula (6) is exemplified.

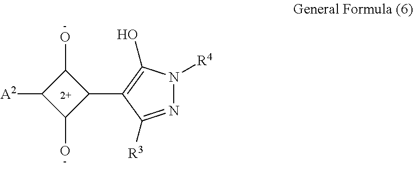

In General Formula (6), R³ and R⁴ each independently represent a hydrogen atom or a substituent and are identical to R³ and R⁴ in General Formula (3), and the preferred ranges are also identical.

A² is identical to A in General Formula (1). Among them, the heterocyclic group that is a nitrogen-containing five-membered ring is preferred.

The pigment represented by General Formula (6) is preferably a pigment represented by any of General Formula (7), General Formula (8), and General Formula (9).

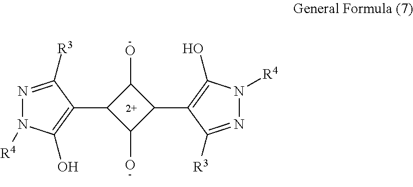

In General Formula (7), R³ and R⁴ each independently represent a hydrogen atom or a substituent and are identical to R³ and R⁴ in General Formula (3), and the preferred ranges are also identical. Two R³'s and two R⁴'s may be identical to or different from each other.

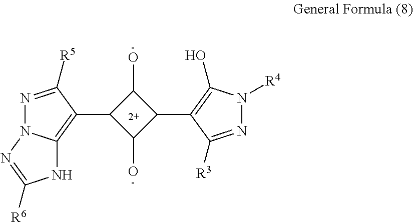

In General Formula (8), R³ and R⁴ each independently represent a hydrogen atom or a substituent and are identical to R³ and R⁴ in General Formula (3), and the preferred ranges are also identical.

R⁵ and R⁶ each independently represent a hydrogen atom or a substituent and are identical to R⁵ and R⁶ in General Formula (4), and the preferred ranges are also identical.

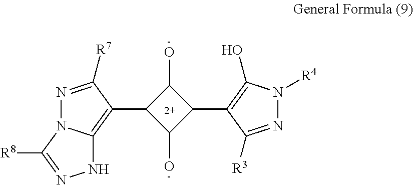

In General Formula (9), R³ and R⁴ each independently represent a hydrogen atom or a substituent and are identical to R³ and R⁴ in General Formula (3), and the preferred ranges are also identical.

R⁷ and R⁸ each independently represent a hydrogen atom or a substituent and are identical to R⁷ and R⁸ in General Formula (5), and the preferred ranges are also identical.

In the present invention, in a case where a squarine-based dye is used as the dye A, the squarine-based dye is not particularly limited, and the squarine-based dyes represented by any of General Formulae (6) to (9) are preferably exemplified. Examples thereof include compounds described in, for example, JP2002-097383A and JP2015-068945A.

Hereinafter, specific examples of the pigments represented by any of General Formula (6) to General Formula (9) will be shown. However, the present invention is not limited thereto.

In the following specific examples, Me represents methyl, Et represents ethyl, i-Pr represents i-propyl, t-Bu represents t-butyl, and Ph represents phenyl respectively. In the following structures, * indicates a bonding site with a four-membered carbon ring in each general formula.

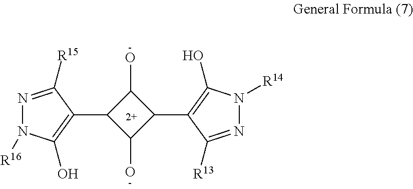

| Compound | | | | |
|---|---|---|---|---|
| No. | R¹³ | R¹⁴ | R¹⁵ | R¹⁶ |
| 7-1 | Me | Me | Me | Me |
| 7-2 | Et | Me | Et | Me |
| 7-3 | Me | 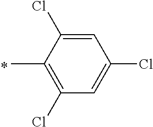 | Me | 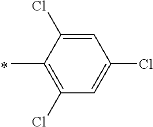 |
| 7-4 | t-Bu | 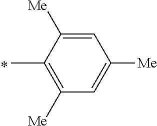 | t-Bu | 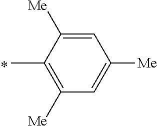 |
| 7-5 | NMe₂ | Me | NMe₂ | Me |
| 7-6 | CN | Me | ON | Me |
| 7-7 | OEt | Me | OEt | Me |
| 7-8 | Me | 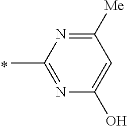 | Me | 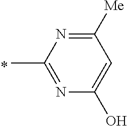 |
| 7-9 | Et | 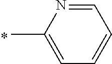 | Et | 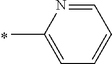 |
| 7-10 | i-Pr | 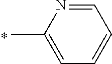 | i-Pr | 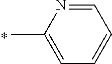 |
| 7-11 | t-Bu | t-Bu | t-Bu | t-Bu |
| 7-12 | CF₃ | Ph | CF₃ | Ph |
| 7-13 | COOEt | Me | COOEt | Me |
| 7-14 | NH₂ | Me | NH₂ | Me |
| 7-15 | Me | Me | Me | 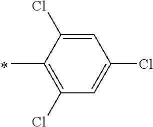 |
| 7-16 | Me | Me | t-Bu | t-Bu |
| 7-17 | Me | Me | NMe₂ | Me |
| 7-18 | Me | Me | Me | Ph |
| 7-19 | Et | Me | Et | 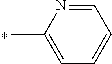 |
| 7-20 | COOEt | Me | Me | 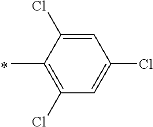 |

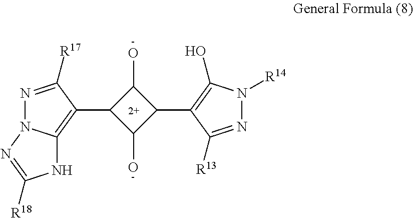

| Compound | | | | |
|---|---|---|---|---|
| No. | R¹³ | R¹⁴ | R¹⁷ | R¹⁸ |
| 8-1 | Me | Me | Me | Me |
| 8-2 | Me | Me | t-Bu | 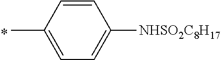 |
| 8-3 | Me | Me | t-Bu | 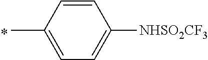 |
| 8-4 | Me | Me | t-Bu | 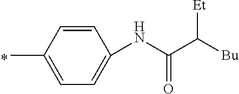 |
| 8-5 | Me | 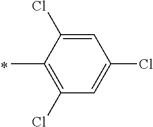 | Me | Me |
| 8-6 | Me | 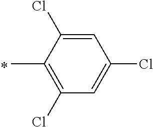 | t-Bu | 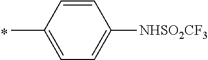 |
| 8-7 | Me | Ph | t-Bu | 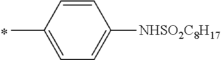 |
| 8-8 | Me | 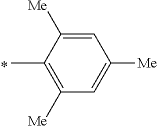 | Me | Me |
| 8-9 | Et | Me | Me | Me |
| 8-10 | i-Pr | Me | Me | Me |
| 8-11 | t-Bu | Me | Me | Me |
| 8-12 | Me | Me | OEt | Bu |
| 8-13 | COOEt | Me | Me | Me |
| 8-14 | NH₂ | Me | Me | Me |
| 8-15 | Me | Me | CF₃ | t-Bu |

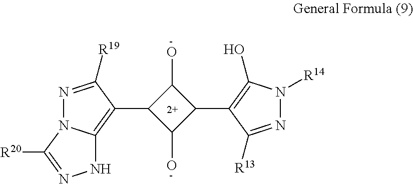

| Compound | | | | |
|---|---|---|---|---|
| No. | R¹³ | R¹⁴ | R¹⁹ | R²⁰ |
| 9-1 | Me | Me | Me | Me |
| 9-2 | Me | Me | t-Bu | 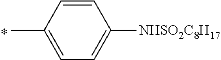 |
| 9-3 | Me | Me | Me | 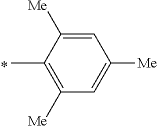 |
| 9-4 | Me | Me | Me | 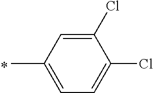 |
| 9-5 | Me | 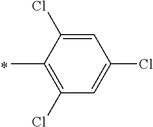 | Me | Me |
| 9-6 | Me | 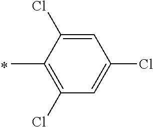 | Me | 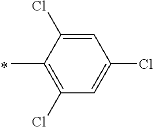 |
| 9-7 | t-Bu | Me | t-Bu | 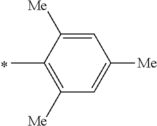 |
| 9-8 | t-Bu | Me | Me | Me |
| 9-9 | Et | Me | t-Bu | Me |
| 9-10 | i-Pr | Me | Me | 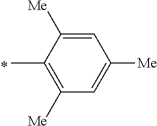 |

As the dye that is used in the present invention, in addition to the dyes A and B, a fluorescent dye having a main absorption wavelength range in a wavelength range other than RGB and having a main light emission wavelength range in a wavelength range that corresponds to a wavelength range of RGB or combinations of two or more of such fluorescent dyes are exemplified.

In the present invention, examples of the wavelength range other than RGB include individual wavelength ranges of 430 nm or lower (for example, 380 nm to 430 nm), 480 nm to 510 nm, and 580 nm to 610 nm. In addition, examples of the wavelength range of RGB include individual wavelength ranges of higher than 430 nm to lower than 480 nm, higher than 510 nm to lower than 580 nm, and higher than 610 nm (for example, higher than 610 nm and 650 nm or lower).

In the present invention, the main absorption wavelength range being in the wavelength range other than RGB means that, in the visible light absorption spectrum (a wavelength range of 380 to 750 nm), among wavelengths of maximum absorption, a wavelength at which the highest absorbance appears is in any of wavelength ranges other than RGB. In addition, the main light emission wavelength range being in the wavelength range that corresponds to the wavelength range of RGB means that, in the visible light absorption spectrum (a wavelength range of 380 to 750 nm), among wavelengths of maximum light emission, a wavelength at which the highest degree of light emission appears is in any of the wavelength range of RGB.

The above-described fluorescent dye is not particularly limited as long as the fluorescent dye has the above-described characteristics, and examples thereof include individual fluorescent dyes such as anthracene-based fluorescent dyes, anthraquinone-based fluorescent dyes, arylmethine-based fluorescent dyes, azo-based fluorescent dyes, azomethine-based fluorescent dyes, bimane-based fluorescent dyes, coumarin-based fluorescent dyes, 1,5-diazabicyclo[3.3.0]octadiene-based fluorescent dyes, diketo-pyrrole-based fluorescent dyes, naphthalenol-imine-based fluorescent dyes, naphthalimide-based fluorescent dyes, perylene-based fluorescent dyes, phenolphthalein-based fluorescent dyes, pyrrole methine-based fluorescent dyes, pyran-based fluorescent dyes, pyrene-based fluorescent dyes, porphycene-based fluorescent dyes, porphyrin-based fluorescent dyes, quinacridone-based fluorescent dyes, rhodamine-based fluorescent dyes, rubrene-based fluorescent dyes, and stilbene-based fluorescent dyes.

Combinations of two or more fluorescent dyes selected from the group consisting of individual fluorescent dyes such as perylene-based fluorescent dyes, azo-based fluorescent dyes, pyrrole methine-based fluorescent dyes, pyran-based fluorescent dyes, and coumarin-based fluorescent dyes are preferably exemplified, and combinations of two or more fluorescent dyes selected from the group consisting of individual fluorescent dyes such as perylene-based fluorescent dyes, pyrrole methine-based fluorescent dyes, pyran-based fluorescent dyes, and coumarin-based fluorescent dyes are more preferably exemplified.

Next, the members (configurational layers) configuring the polarizing plate of the present invention will be described.

<Polarizing Plate Protective Film>

The polarizing plate protective film is a film-like layer formed by containing a polymer. The number of polymers that the polarizing plate protective film contains may be one or more.

As the polymer that is used in the polarizing plate protective film, a well-known polymer can be used, and there is no particular limitation within the scope of the gist of the present invention. As the polymer, a cellulose acylate polymer, an acryl polymer, a cycloolefin-based polymer, and the like can be exemplified. Among these, a cellulose acylate polymer or a cycloolefin-based polymer is preferred.

The details of individual polymers that are used in the present invention will be described below; however, in the present invention, the polymer is preferably selected in consideration of the dye in order to effectively suppress the decomposition of the dye (in order for liquid crystal display devices to exhibit excellent light resistance).

For example, for the dyes represented by Formula (1) to Formula (9), a polymer obtained by combining a cycloolefin-based polymer is preferably employed. For dyes other than the dyes A and B, a polymer obtained by combining a cellulose acylate polymer is preferably employed, and a polymer obtained by combining a cellulose acylate polymer having a high glass transition temperature (Tg) is more preferably employed.

Hereinafter, first, a cellulose acylate polymer that is preferably used in the present invention and an additive that can be jointly used with a cellulose acylate will be described.

(Cellulose Acylate Polymer)

As the cellulose acylate polymer (hereinafter, referred to as the cellulose acylate), a well-known cellulose acylate that is used to manufacture cellulose acylate films can be used without any particular limitations.

The degree of acyl substitution (hereinafter, in some cases, simply referred to as “the degree of substitution”) is an index indicating the degree of acylation of hydroxy groups in cellulose located at the 2-position, the 3-position, and the 6-position, and, in a case where all of hydroxy groups in the 2-position, the 3-position, and the 6-position of all of glucose units are acylated, the total degree of acyl substitution is three. For example, in a case in which all of hydroxy groups only in the 6-position are acylated in all of glucose units, the total degree of acyl substitution is one. Similarly, in a case where, among all of hydroxy groups in all of glucose units, all of hydroxy groups in any one of the 6-position and the 2-position in the respective glucose units are acylated, the total degree of acyl substitution is also one.

That is, the degree of substitution is an index that indicates the degree of acylation which has a value of three in a case where all of hydroxy groups in a glucose molecule are all acylated.

The degree of substitution of the cellulose acylate can be measured according to a method described in Tezuka et al, Carbohydrate. Res., 273, 83-91 (1995) or a method regulated in ASTM-D817-96.

The total degree of acyl substitution of the cellulose acylate that is used in the present invention is preferably 1.50 or higher and 3.00 or lower, more preferably 2.00 to 2.97, still more preferably 2.30 or more and lower than 2.97, and particularly preferably 2.30 to 2.95 from the viewpoint of moisture permeability.

An acyl group in the cellulose acylate that is used in the present invention is not particularly limited, and the cellulose acylate may have one type of acyl group and may have two or more types of acyl groups. A cellulose acylate that can be used in the present invention preferably has an acyl group having two or more carbon atoms as a substituent. The acyl group having two or more carbon atoms is not particularly limited and may be an aliphatic acyl group or may be an aromatic acyl group. A cellulose acylate substituted by this acyl group is, for example, an alkylcarbonyl ester, an alkenylcarbonyl ester, an aromatic carbonyl ester, an aromatic alkylcarbonyl ester, or the like of cellulose, and these cellulose acylates may further have a substituted group.

Specific examples of the acyl group having two or more carbon atoms include acetyl, propionyl, butanoyl, heptanoyl, hexanoyl, octanoyl, decanoyl, dodecanoyl, tridecanoyl, tetradecanoyl, hexadecanoyl, octadecanoyl, isobutanoyl, tert-butanoyl, cyclohexanecarbonyl, oleoyl, benzoyl, naphthylcarbonyl, cinnamoyl, and the like. Among these, acetyl, propionyl, butanoyl, dodecanoyl, octadecanoyl, tert-butanoyl, oleoyl, benzoyl, naphthylcarbonyl, and cinnamoyl are preferred, acetyl, propionyl, and butanoyl are more preferred, and acetyl is particularly preferred.

The cellulose acylate preferably has an acyl group having 2 to 4 carbon atoms as a substituent. In a case where two or more types of acyl groups are used, one of the acyl groups is preferably an acetyl group. These cellulose acylates enable the production of solutions having a preferable solubility, and, particularly, in non-chlorine-based organic solvents, it becomes possible to produce favorable solutions. Furthermore, it becomes possible to produce solutions having a low viscosity and favorable filterability.

A cellulose acetate in which only an acetyl group is used as the acyl group in the cellulose acylate can be preferably used in the present invention, and the total degree of acyl substitution of this cellulose acetate is preferably 2.00 to 3.00, more preferably 2.20 to 3.00, still more preferably 2.30 to 3.00, particularly preferably 2.30 to 2.97, and most preferably 2.30 to 2.95 from the viewpoint of moisture permeability and optical characteristics.

A mixed aliphatic acid ester having two or more types of acyl groups can also be preferably used as the cellulose acylate that forms the polarizing plate protective film. Particularly, an acetyl group and an acyl group having 3 or 4 carbon atoms are preferably included as the acyl group in the mixed aliphatic acid ester. In addition, in a case where the mixed aliphatic acid ester includes an acetyl group as the acyl group, the degree of acetyl substitution is preferably lower than 2.5 and more preferably lower than 1.9. Meanwhile, in a case where the mixed aliphatic acid ester includes an acyl group having 3 or 4 carbon atoms, the degree of substitution of the acyl group having 3 or 4 carbon atoms is preferably 0.1 to 1.5, more preferably 0.2 to 1.2, and particularly preferably 0.5 to 1.1.

In addition, mixed acid esters having an aliphatic acid acyl group and a substituted or unsubstituted aromatic acyl group, which are described in Paragraphs [0023] to [0038] of JP2008-020896A can also be preferably used.

In the present invention, it is also possible to jointly use two cellulose acylates for which one or both of an ester group and the degree of substitution differs. In this case, the polarizing plate protective film may be formed as a laminated structure including different cellulose acylates by a co-casting method or the like described below.

The degree of polymerization of the cellulose acylate that is used in the present invention is preferably 250 to 800 and more preferably 300 to 600. In addition, the number-average molecular weight of the cellulose acylate that is used in the present invention is preferably 40,000 to 230,000, more preferably 60,000 to 230,000, and most preferably 75,000 to 200,000.

The degree of polymerization can be obtained by dividing the number-average molecular weight that is measured by gel permeation chromatography (GPC) in terms of polystyrene by the molecular weight of a glucopyranose unit of the cellulose acylate.

The cellulose acylate that is used in the present invention can be synthesized using a normal method. For example, the cellulose acylate can be synthesized using an acid anhydride or an acid chloride as an acylating agent. In a case where the acylating agent is an acid anhydride, an organic acid (for example, acetic acid) or methylene chloride is used as a reaction solvent. In addition, as a catalyst, a protonic catalyst such as sulfuric acid can be used. In a case where the acylating agent is an acid chloride, a basic compound can be used as the catalyst. In the ordinary industrial production of the cellulose acylate, a hydroxy group in cellulose is esterified using an organic acid (acetic acid, propionic acid, butyric acid, or the like) or an acid anhydride thereof (an acetic acid anhydride, a propionic acid anhydride, a butyric acid anhydride, or the like) that matches cellulose to a target acyl group.

For example, cellulose derived from a cotton linter or wood pulp is used as a raw material, an activation treatment is carried out on this cellulose using an organic acid such as acetic acid, and then the cellulose is esterified using an organic acid having a desired structure in the presence of a sulfuric acid catalyst, whereby the cellulose acylate can be obtained. In addition, in a case where an organic acid anhydride is used as the acylating agent, it is possible to acylate cellulose using an excess amount of the organic acid anhydride with respect to the amount of a hydroxy group present in the cellulose.

In addition, the cellulose acylate can also be synthesized using, for example, a method described in JP1998-045804A (JP-H10-045804A).

The polarizing plate protective film containing the cellulose acylate preferably contains 5% to 99% by mass of the cellulose acylate as a polymer from the viewpoint of moisture permeability, more preferably contains 20% to 99% by mass of the cellulose acylate, and particularly preferably contains 50% to 95% by mass of the cellulose acylate.

The number of the cellulose acylates that the polarizing plate protective film contains may be two or more, and polymers having different compositional ratios and/or molecular weights may be jointly used. In this case, the total content of the respective polymers needs to be in the above-described range.

(Additive That is Jointly Used With Cellulose Acylate)

The polarizing plate protective film containing the cellulose acylate may also include an additive as long as the effect of the present invention is not impaired. As the additive, well-known plasticizers, organic acids, polymers, retardation adjusters, ultraviolet absorbers, antioxidants, matting agents, and the like are exemplified. Regarding these additives, it is possible to reference the description of Paragraphs [0062] to [0097] of JP2012-155287A, the content of which is incorporated into the specification of the present application. In addition, as the additive, peel accelerators, organic acids, and polyhydric carboxylic acid derivatives can also be exemplified. Regarding these additives, it is possible to reference the description of Paragraphs [0212] to [0219] of WO2015/005398A, the content of which is incorporated into the specification of the present application. Furthermore, as the additive, radical scavengers, deterioration inhibitors, barbituric acid compounds, and the like, which will be described below, can also be exemplified.

The content of the additive (the total content in a case where the polarizing plate protective film contains two or more additives) is preferably 50 parts by mass or less, more preferably 30 parts by mass or less, and still more preferably 5 to 30 parts by mass with respect to 100 parts by mass of the cellulose ester.

—Plasticizer—

As one of preferred additives, a plasticizer can be exemplified. In a case where a plasticizer is added to the polarizing plate protective film, it is possible to enhance the hydrophobicity of the polarizing plate protective film. A plasticizer is preferably added to the polarizing plate protective film from the viewpoint of decreasing the moisture permeability of the polarizing plate protective film. The use of the above-described plasticizer suppresses the generation of display unevenness in image display devices, which is attributed to humidity, in a case where the polarizing plate protective film is used in the image display devices.

The plasticizer is not particularly limited, and polyhydric ester compounds of polyhydric alcohols (hereinafter, also referred to as “polyhydric alcohol ester plasticizers”), polycondensation ester compounds (hereinafter, also referred to as “polycondensation ester plasticizers”), and carbohydrate compounds (hereinafter, also referred to as “carbohydrate derivative plasticizers”) can be exemplified. Regarding the polyhydric alcohol ester plasticizers, the polycondensation ester plasticizers, and the carbohydrate derivative plasticizers, it is possible to reference Paragraphs [0081] to [0098], Paragraphs [0099] to [0122], and Paragraphs [0123] to [0140] of WO2015/005398A respectively, the contents of which are incorporated into the specification of the present application.

The molecular weight of the plasticizer is preferably 3,000 or lower, more preferably 1,500 or lower, and still more preferably 1,000 or lower from the viewpoint of favorably obtaining the above-described effect of the addition of the plasticizer. In addition, the molecular weight of the plasticizer is, for example, 300 or higher and preferably 350 or higher from the viewpoint of weak volatile properties. Meanwhile, for the plasticizers for multimers, the molecular weight refers to the number-average molecular weight.

The content of the plasticizer is preferably set to 1 to 20 parts by mass, more preferably set to 2 to 15 parts by mass, and still more preferably set to 5 to 15 parts by mass with respect to 100 parts by mass of the cellulose acylate from the viewpoint of satisfying both the addition effect of the plasticizer and the precipitation suppression by the plasticizer.

Two or more plasticizers may be jointly used. Even in a case where two or more plasticizers are jointly used, the specific examples and the preferred range of the content are identical to the above description.

—Antioxidant—

As one of preferred additives, an antioxidant can also be exemplified. Regarding the antioxidant, it is possible to reference the description of Paragraphs [0143] to [0165] of WO2015/005398A, the content of which is incorporated into the specification of the present application.

—Radical Scavenger—

As one of preferred additives, a radical scavenger can also be exemplified. Regarding the radical scavenger, it is possible to reference the description of Paragraphs [0166] to [0199] of WO2015/005398A, the content of which is incorporated into the specification of the present application.

—Deterioration Inhibitor—

As one of preferred additives, a deterioration inhibitor can also be exemplified. Regarding the deterioration inhibitor, it is possible to reference the description of Paragraphs [205] and [0206] of WO2015/005398A, the content of which is incorporated into the specification of the present application.

—Ultraviolet Absorber—

In the present invention, an ultraviolet absorber may be added to the polarizing plate protective film from the viewpoint of preventing the deterioration of the polarizing plate, liquid crystals, and the like. As the ultraviolet absorber, an ultraviolet absorber that does not absorb much visible light having a wavelength range of 400 nm or higher from the viewpoint of an excellent capability of absorbing ultraviolet rays having a wavelength range of 370 nm or lower and favorable liquid crystal display properties. Specific examples of an ultraviolet absorber that is preferably used in the present invention include hindered phenol-based compounds, hydroxybenzophenone-based compounds, benzotriazole-based compounds, salicylic acid ester-based compounds, benzophenone-based compounds, cyanoacrylate-based compounds, nickel complex salt-based compounds, and the like.

Examples of the hindered phenol-based compound include 2,6-di-tert-butyl-p-cresol, pentaerythrityl tetrakis[3-(3,5-di-tert-butyl-4-hydroxyphenyl)propionate], N,N′-hexamethylene bis(3,5-di-tert-butyl-4-hydroxy-hydrocinnamide), 1,3,5-trimethyl-2,4,6-tris(3,5-di-tert-butyl-4-hydroxybenzyl)benzene, tris(3,5-di-tert-butyl-4-hydroxybenzyl)-isocyanurate, and the like. Examples of the benzotriazole-based compounds include 2-(2′-hydroxy-5′-methylphenyl) benzotriazole, 2,2-methylene bis(4-(1,1,3,3-tetramethylbutyl)-6-(2H-benzotriazole-2-yl)phenyl), (2,4-bis-(n-octylthio)-6-(4-hydroxy-3,5-di-tert-butylanilino)-1,3,5-triazine, triethylene glycol bis(3-(3-tert-butyl-5-methyl-4-hydroxyphenyl)propionate], N,N′-hexamethylene bis(3,5-di-tert-butyl-4-hydroxy-hydrocinnamide), 1,3,5-trimethyl-2,4,6-tris(3,5-di-tert-butyl-4-hydroxybenzyl)benzene, 2(2′-hydroxy-3,5′-di-tert-butylphenyl)-5-chlorbenzotriazole, (2(2′-hydroxy-3,5′-di-tert-amylphenyl)-5-chlorobenzotriazole, 2,6-di-tert-butyl-p-cresol, pentaerythrityl tetrakis[3-(3,5-di-tert-butyl-4-hydroxyphenyl)propionate], 2-(2H-benzotriazole-2-yl)-6-(1-methyl-1-phenylethyl)-4-(1,1,3,3-tetramethylbutyl) phenol, and the like.

The polarizing plate protective film preferably contains 0.01% by mass or more and 5% by mass or less of the ultraviolet absorber with respect to the polymer. The content of an ultraviolet absorber A is preferably 0.5% by mass or more and 4.0% by mass or less and more preferably 1.5% by mass or more and 3.5% by mass or less of the polymer.

Next, a cycloolefin-based polymer that is preferably used in the present invention and an additive that can be jointly used with the cycloolefin-based polymer will be described.

(Cycloolefin-Based Polymer)

A cyclic olefin compound that forms the cycloolefin-based polymer (also referred to as the cyclic polyolefin) is not particularly limited as long as the cyclic olefin compound is a compound having a ring structure including a carbon-carbon double bond, and examples thereof include norbornene compounds and monocyclic olefin compounds, cyclic conjugated diene compounds, vinyl alicyclic hydrocarbon compounds, which are not norbornene compounds, and the like.

Examples of the cyclic polyolefin include (1) polymers including a structural unit derived from a norbornene compound, (2) polymers including a structural unit derived from a monocyclic olefin compound other that is not a norbornene compound, (3) polymers including a structural unit derived from a cyclic conjugated diene compound, (4) polymers including a structural unit derived from a vinyl alicyclic hydrocarbon compound, hydrides of polymers including a structural unit derived from each of the compounds (1) to (4), and the like. In the present invention, ring-opening polymers of the respective compounds are considered as the polymers including a structural unit derived from a norbornene compound and the polymers including a structural unit derived from a monocyclic olefin compound.

The cyclic polyolefin is not particularly limited, but a polymer having a structural unit derived from a norbornene compound, which is represented by General Formula (A-II) or (A-III), is preferred. The polymer having the structural unit represented by General Formula (A-II) is an addition polymer of a norbornene compound, and the polymer having the structural unit represented by General Formula (A-III) is a ring-opening polymer of a norbornene compound.

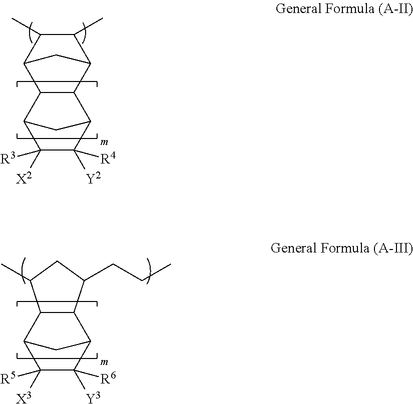

In the general formulae, m represents an integer of 0 to 4 and is preferably 0 or 1.

R³ to R⁶ each independently represent a hydrogen atom or a hydrocarbon group having 1 to 10 carbon atoms.

In the present invention, a hydrocarbon group is not particularly limited as long as the hydrocarbon group is a group made up of a carbon atom and a hydrogen atom, and an alkyl group, an alkenyl group, an alkynyl group, an aryl group (an aromatic hydrocarbon group), and the like are exemplified. Among these, an alkyl group or an aryl group is preferred.

X², X³, Y², and Y³ each independently represent a hydrogen atom, a hydrocarbon group having 1 to 10 carbon atoms, a halogen atom, a hydrocarbon group having 1 to 10 carbon atoms which is substituted by a halogen atom, —(CH₂)nCOOR¹¹, —(CH₂)nOCOR¹², —(CH₂)nNCO, —(CH₂)nNO₂, —(CH₂)nCN, —(CH₂)nCONR¹³R¹⁴, —(CH₂)nNR¹³R¹⁴, —(CH₂)nOZ, —(CH₂)nW, or (—CO)₂O or (—CO)₂NR¹⁵ which is formed by the bonding between X² and Y² or X³ and Y³.

Here, R¹¹ to R¹⁵ each independently represent a hydrogen atom or a hydrocarbon group having 1 to 20 carbon atoms, Z represents a hydrocarbon group or a hydrocarbon group substituted by halogen, W represents Si(R¹⁶)ₚD₍₃₋ₚ₎ (R¹⁶ represents a hydrocarbon group having 1 to 10 carbon atoms, and D represents a halogen atom, —COR¹⁷, or —OR¹⁷ (R¹⁷ represents a hydrocarbon group having 1 to 10 carbon atoms. p is an integer of 0 to 3.)). n is an integer of 0 to 10, preferably 0 to 8, and more preferably 0 to 6.

In General Formula (A-II) or (A-III), R³ to R⁶ are each preferably a hydrogen atom or —CH₃, and, from the viewpoint of moisture permeability, more preferably a hydrogen atom.

X² and X³ are each preferably a hydrogen atom, —CH₃, or —C₂H₅ and, from the viewpoint of moisture permeability, more preferably a hydrogen atom.

Y² and Y³ are each preferably a hydrogen atom, a halogen atom (particularly a chlorine atom), or —(CH₂)nCOOR¹¹ (particularly —COOCH₃) and, from the viewpoint of moisture permeability, more preferably a hydrogen atom.

The other groups are appropriately selected.

The polymer having the structural unit represented by General Formula (A-II) or (A-III) may further include at least one structural unit represented by General Formula (A-I).

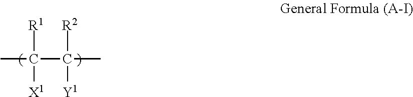

In the general formula, R¹ and R² each independently represent a hydrogen atom or a hydrocarbon group having 1 to 10 carbon atoms, and X¹ and Y¹ each independently represent a hydrogen atom, a hydrocarbon group having 1 to 10 carbon atoms, a halogen atom, a hydrocarbon group having 1 to 10 carbon atoms which is substituted by a halogen atom, —(CH₂)nCOOR¹¹, —(CH₂)nOCOR¹², —(CH₂)nNCO, —(CH₂)nNO₂, —(CH₂)nCN, —(CH₂)nCONR¹³R¹⁴, —(CH₂)nNR¹³R¹⁴, —(CH₂)nOZ, —(CH₂)nW, or (—CO)₂O or (—CO)₂NR¹⁵ which is formed by the bonding between X¹ and Y¹.

Here, R¹¹ to R¹⁵ each independently represent a hydrogen atom or a hydrocarbon group having 1 to 20 carbon atoms, Z represents a hydrocarbon group or a hydrocarbon group substituted by halogen, W represents Si(R¹⁶)ₚD₍₃₋ₚ₎ (R¹⁶ represents a hydrocarbon group having 1 to 10 carbon atoms, and D represents a halogen atom, —COR¹⁷, or —OR¹⁷ (R¹⁷ represents a hydrocarbon group having 1 to 10 carbon atoms), and p is an integer of 0 to 3). n represents an integer of 0 to 10.

From the viewpoint of adhesiveness to the polarizer, the content of the above-described structural unit derived from a norbornene compound in the cyclic polyolefin having the structural unit represented by General Formula (A-II) or (A-III) is preferably 90% by mass or less, more preferably 30% to 85% by mass, still more preferably 50% to 79% by mass, and most preferably 60% to 75% by mass with respect to the total mass of the cyclic polyolefin. Here, the proportion of the structural unit derived from a norbornene compound represents the average value in the cyclic polyolefin.

The addition (co)polymer of a norbornene compound is described in JP1998-007732A (JP-H10-007732A), JP2002-504184A, US2004/229157A1A, or WO2004/070463A.

The polymer of a norbornene compound is obtained by the addition polymerization of norbornene compounds (for example, polycyclic unsaturated compounds of norbornene).

In addition, as the polymer of a norbornene compound, copolymers obtained by the addition copolymerization of, as necessary, a norbornene compound, olefin such as ethylene, propylene, or butene, conjugated diene such as butadiene or isoprene, unconjugated diene such as ethylidene norbornene, and an ethylenically unsaturated compound such as acrylonitrile, acrylic acid, methacrylic acid, maleic acid anhydride, acrylic acid ester, methacrylic acid ester, maleimide, vinyl acetate, or vinyl chloride are exemplified. Among these, copolymers with ethylene are preferred.

Examples of the above-described addition (co)polymers of a norbornene compound include APL8008T (Tg: 70° C.), APL6011T (Tg: 105° C.), APL6013T (Tg: 125° C.), and APL6015T (Tg: 145° C.) which are launched by Mitsui Chemicals, Inc. under a trade name of APEL and have mutually different glass transition temperatures (Tg). In addition, pellets such as TOPAS8007, TOPAS6013, and TOPAS6015 are put on the market by Polyplastics Co., Ltd. Furthermore, Appear3000 is put on the market by Film Ferrania S. R. L.

As the above-described polymer of a norbornene compound, commercially available products can be used. For example, polymers are put on the market by JSR Corporation under a trade name of Arton G or Arton F, and polymers are put on the market by Zeon Corporation under a trade name of Zeonor ZF14, Zf16, Zeonex 250, or Zeonex 280.

The hydride of a polymer of a norbornene compound can be synthesized by the addition polymerization or the metathesis ring-opening polymerization of a norbornene compound or the like and then the addition of hydrogen. A synthesis method is described in, for example, JP1989-240517A (JP-H1-240517A), JP1995-196736A (JP-H7-196736A), JP1985-026024A (JP-S60-026024A), JP1987-019801A (JP-S62-019801A), JP2003-159767A, JP2004-309979A, and the like.

The molecular weight of the cycloolefin-based polymer that is used in the present invention is appropriately selected depending on the intended use, but the polyisoprene or polystyrene-equivalent weight-average molecular weight measured by the gel permeation chromatography of a cyclohexane solution (a toluene solution in a case where the polymer is not dissolved) is in a range of, generally, 5,000 to 500,000, preferably 8,000 to 200,000, and more preferably 10,000 to 100,000. A polymer having a molecular weight in the above-described range is capable of satisfying both the mechanical strength and the molding workability of compacts at a high level in a well-balanced manner.

In the polarizing plate protective film containing the cycloolefin-based polymer, the content of the cycloolefin-based polymer as the polymer is preferably 50% to 100% by mass from the viewpoint of the absorption waveform and the light resistance of the dye, more preferably 70% to 100% by mass, and particularly preferably 90% to 100% by mass.

The number of the cycloolefin-based polymers that the polarizing plate protective film contains may be two or more, and polymers having different compositional ratios and/or molecular weights may be jointly used. In this case, the total content of the respective polymers needs to be in the above-described range.

(Additive That Can be Jointly Used With Cycloolefin-Based Polymer)

The polarizing plate protective film containing the cycloolefin-based polymer may also contain an additive that can be generally blended into plastic films as necessary. As such an additive, antioxidants, thermal stabilizers, light stabilizers, ultraviolet absorbers, antistatic agents, lubricants, plasticizers, fillers, and the like are exemplified, and specific examples thereof include those described in the section of the additive material that can be jointly used with the cellulose acylate.

The content of the additive that can be jointly used with the cycloolefin-based polymer can be appropriately determined as long as the object of the present invention is not impaired.

(Method For Producing Polarizing Plate Protective Film)

Hereinafter, a method for producing the polarizing plate protective film will be described.

The polarizing plate protective film is not particularly limited and can be appropriately produced using a well-known molding method. Hereinafter, a method for manufacturing the polarizing plate protective film will be described using an aspect in which the cellulose acylate is used as an example; however, even in a case where the cycloolefin-based polymer, an acrylic polymer, and other polymers are used, the polarizing plate protective film can be manufactured in the same manner.

The polarizing plate protective film is not particularly limited and can be manufactured using a solution casting film-forming method. In the solution casting film-forming method, the film is manufactured using a solution (dope) obtained by dissolving the cellulose acylate in an organic solvent.

The organic solvent preferably includes a solvent selected from an ether having 3 to 12 carbon atoms, a ketone having 3 to 12 carbon atoms, an ester having 3 to 12 carbon atoms, and a hydrocarbon halide having 1 to 6 carbon atoms.

The ether, the ketone, and the ester may have a cyclic structure. In addition, a compound having two or more of any functional groups (that is, —O—, —CO—, and —COO—) of the ether, the ketone, and the ester can also be used as the organic solvent. The organic solvent may further have a different functional group such as an alcoholic hydroxyl group. In the case of an organic solvent having two or more types of functional groups, the number of carbon atoms is preferably in the above-described preferred range of the number of carbon atoms of a solvent having any functional group.

The content of the cellulose acylate in the cellulose acylate solution is preferably adjusted to 10% to 40% by mass. The content of the cellulose acylate is more preferably 10% to 30% by mass. To the organic solvent (main solvent), any additives described above may be added.

Regarding a drying method in the solution casting film-forming method, it is possible to reference individual specifications of U.S. Pat. Nos. 2,336,310A, 2,367,603A, 2,492,078A, 2,492,977A, 2,492,978A, 2,607,704A, 2,739,069A, and 2,739,070A, individual specifications of GB640731A and GB736892A, JP1970-004554B (JP-S45-004554B), JP1974-005614B (JP-S49-005614B), JP1985-176834A (JP-S60-176834A), JP1985-203430A (JP-S60-203430A), and JP1987-115035A (JP-S62-115035A). Drying on a band or a drum can be carried out by blowing the air or an inert gas such as nitrogen.

It is also possible to cast two or more layers using the prepared cellulose acylate solution (dope) and turn the layers into the film. In this case, the cellulose acylate film is preferably produced using the solution casting film-forming method. It is preferable that the dope is cast on a drum or a band and is formed into the film by drying the solvent. For the dope to be cast, it is preferable to adjust the concentration so that the amount of a solid content falls in a range of 10% to 40% by mass. The surface of the drum or the band is preferably finished to a mirror-surface state.

In the case of casting a plurality (two or more) of layers of the cellulose acylate solution, the film may be produced while casting the solution including the cellulose acylate from a plurality of casting openings provided at intervals in a travelling direction of a support and respectively laminating layers. For this, it is possible to use a method described in each of, for example, JP1986-158414A (JP-S61-158414A), JP1989-122419A (JP-H1-122419A), and JP1999-198285A (JP-H11-198285A). In addition, it is also possible to produce the film by casting the cellulose acylate solution from two casting openings. For this, it is possible to use a method described in each of, for example, JP1985-027562B (JP-S60-027562B), JP1986-094724A (JP-S61-094724A), JP1986-947245A (JP-S61-947245A), JP1986-104813A (JP-S61-104813A), JP1986-158413A (JP-S61-158413A), and JP1994-134933A (JP-H6-134933A). Furthermore, it is also possible to use a casting method of the cellulose acylate film described in JP1981-162617A (JP-S56-162617A) in which the flow of a high-viscosity cellulose acylate solution is enclosed by a cellulose acylate solution having a low viscosity and these cellulose acylate solutions having a high or low viscosity are extruded at the same time.

In addition, it is also possible to produce the film by using two casting openings, peeling off a film molded on a support using a first casting opening, and carrying out the second casting on a side in contact with the surface of the support. Examples thereof include a method described in JP1969-020235B (JP-S44-020235B).

As the cellulose acylate solutions to be cast, the same solution may be used or two or more different cellulose acylate solutions may be used. In order to provide functions to a plurality of cellulose acylate layers, cellulose acylate solutions suitable for the functions may be extruded from individual casting openings. Furthermore, the cellulose acylate solution in the present invention can also be cast at the same time as other functional layers (for example, an adhesive layer, a dye layer, an antistatic layer, an antihalation layer, an ultraviolet-absorbing layer, a polarizing layer, and the like).

FIG. 4 is an enlarged partial pattern diagram showing an example of the production method (co-casting) of the polarizing plate protective film. The production method shown in FIG. 4 will be further described in examples described below.

(Addition of Dye)

In the polarizing plate of the present invention, in a case where the polarizing plate protective film contains the dye, a timing at which the dye is added to the cellulose acylate solution that is an example of the polymer raw material of the polarizing plate protective film is not particularly limited as long as the dye is added to the cellulose acylate solution at the time of forming the film. For example, the dye may be added at the time of synthesizing the cellulose acylate or during the synthesis of the cellulose acylate, and the dye may be mixed with the cellulose acylate at the time of preparing the dope.

(Drying Treatment)

Steps from the casting of the dope to post drying may be carried out under the air atmosphere or under an atmosphere of an inert gas such as nitrogen gas. A winder that is used to manufacture the polarizing plate protective film in the present invention may be an ordinarily-used winder, and the film can be wound using a winding method such as a constant tension method, a constant torque method, a taper tension method, or a program tension control method with a constant internal stress.

(Stretching Treatment)

On the polarizing plate protective film, a stretching treatment can also be carried out. With the stretching treatment, it is possible to impart a desired retardation to the polarizing plate protective film. A stretching direction of the cellulose acylate film is preferably any of the width direction and the longitudinal direction.

A method for stretching the polarizing plate protective film in the width direction is described in each of, for example, JP1987-115035A (JP-S62-115035A), JP1992-152125A (JP-H4-152125A), JP1992-284211A (JP-H4-284211A), JP1992-298310A (JP-H4-298310A), JP1999-048271A (JP-H11-048271A), and the like.

The film is stretched under a heating condition. The film can be stretched by the treatment during drying, which is particularly effective in a case where the solvent remains. In the case of stretching the film in the longitudinal direction, the film is stretched by, for example, adjusting the rate of a transportation roller for the film to set the wind rate of the film to be faster than the peel rate of the film. In the case of stretching the film in the width direction, the film can be stretched by transporting the film with the width of the film held using a tenter and gradually broadening the width of the tenter. It is also possible to stretch the film using a stretcher after the drying of the film (preferably monoaxially stretch the film using a long stretcher).

(Saponification Treatment)

In the case of being subjected to an alkali saponification treatment, the polarizing plate protective film is imparted with adhesiveness to a material of the polarizer such as polyvinyl alcohol and can be used as a polarizing plate protective film.

Regarding a method for saponification, it is possible to use a method described in [0211] and [0212] of JP2007-086748A.

For example, the alkali saponification treatment on the polarizing plate protective film is preferably carried out in a cycle in which the surface of the film is immersed in an alkali solution, then, neutralized with an acidic solution, washed with water, and dried. As the alkali solution, a potassium hydroxide solution and a sodium hydroxide solution are exemplified, and the concentration of a hydroxide ion is preferably in a range of 0.1 to 5.0 mol/L and more preferably in a range of 0.5 to 4.0 mol/L. The temperature of the alkali solution is preferably in a range of room temperature to 90° C. and more preferably in a range of 40° C. to 70° C.

Instead of the alkali saponification treatment, an easy adhesion process as described in JP1994-094915A (JP-H6-094915A) and JP1994-118232A (JP-H6-118232A) may be carried out.

In addition, in a case where the polarizing plate protective film contains the cycloolefin-based polymer, the wetting tension of the surface is preferably 40 mN/m or more, more preferably 50 mN/m or more, and still more preferably 55 mN/m or more. In a case where the wetting tension of the surface is in the above-described range, the adhesion strength between the film and the polarizer improves. In order to adjust the wetting tension of the surface, it is possible to carry out, for example, a corona discharge treatment, the blowing of ozone, the irradiation with ultraviolet rays, a flame treatment, a chemical treatment, or other well-known surface treatments.

In the method for producing the polarizing plate protective film containing the cycloolefin-based polymer, the polarizing plate protective film can be produced as described above, and, furthermore, for example, any of a heating and melting molding method and a solution casting method can be used. The heating and melting molding method can be, in more detail, classified into an extrusion molding method, a press molding method, an inflation molding method, an injection molding method, a blow molding method, a stretching molding method, and the like, and, among these methods, in order to obtain films being excellent in terms of the mechanical strength, the surface accuracy, and the like, an extrusion molding method, an inflation molding method, and a press molding method are preferred, and an extrusion molding method is most preferred. Molding conditions are appropriately selected depending on the intended use or the molding method; however, in the case of using the heating and melting molding method, the temperature of a cylinder is appropriately set in a range of, generally, 150° C. to 400° C., preferably 200° C. to 350° C., and more preferably 230° C. to 330° C. In a case where the temperature of the polymer is low, the fluidity deteriorates, and sink marks or strains are generated in the film, and, in a case where the temperature of the polymer is excessively high, there is a concern that voids or silver streaks may be generated due to the thermal decomposition of the polymer or the film may turn yellow, thereby causing poor molding.

Preferred physical properties or characteristics of the polarizing plate protective film configuring the polarizing plate of the present invention will be described.

[Film Thickness of Polarizing Plate Protective Film]

The film thickness of the polarizing plate protective film is generally 5 μm or more and 120 μm or less, preferably 10 μm or more and 100 μm or less, and more preferably 15 μm or more and 60 μm or less. In the case of being combined into liquid crystal display devices, thin films do not easily cause display unevenness after being aged at a high temperature and a high humidity, which is preferable. On the other hand, in a case where the polarizing plate protective film is excessively thick, it becomes difficult to stably transport the polarizing plate protective film during the manufacturing of the film and the production of the polarizing plate.

The polarizing plate of the present invention also preferably comprises a polarizing plate protective film having a thick film thickness. In this aspect, it is possible to set the film thickness of the polarizing plate protective film to 20 μm or more. In a case where the film thickness is set to 20 μm or more, it is possible to decrease the concentration of the dye in the film, and an effect for improving light resistance can be obtained. The lower limit value of the film thickness in this aspect is preferably 25 μm or more and more preferably 30 μm or more. The upper limit value of the film thickness in this aspect is as described above.

[Absorbance of Polarizing Plate Protective Film]

The absorbance at a wavelength of 480 nm of the polarizing plate protective film is preferably 0.05 or more and 3.0 or less, more preferably 0.01 or more and 2.0 or less, and still more preferably 0.1 or more and 1.5 or less.

In addition, the absorbance at a wavelength of 580 nm is preferably 0.1 or more and 3.0 or less, more preferably 0.2 or more and 2.5 or less, and still more preferably 0.5 or more and 2.0 or less.

In a case where a polarizing plate including a polarizing plate protective film having an absorbance adjusted to the above-described ranges is combined into liquid crystal display devices, display performance having a high brightness and favorable color reproducibility can be obtained.

The absorbance of the polarizing plate protective film can be adjusted using the type of the dye and the amount of the dye added.

[Retardation of Polarizing Plate Protective Film]

In the present invention, Re (λ) and Rth (λ) each represent an in-plane retardation and a retardation in a thickness direction at a wavelength of λ. Unless particularly otherwise described, the wavelength λ is 590 nm.

In the present invention, Re (λ) and Rth (λ) are values measured at the wavelength of λ in AxoScan OPMF-1 (manufactured by Opto Science, Inc.). By inputting an average refractive index ((Nx+Ny+Nz)/3) and a film thickness (d(μm)) in AxoScan,
Slow axis (λ),
Re (λ)=R0(λ), and
Rth (λ)=(Nz−(Nx+Ny)/2)*d
are computed.

Here, Nx represents a refractive index of the film in a slow axis direction, Ny represents a refractive index of the film in the fast axis direction, and Nz represents a refractive index of the film in the thickness direction.

Rth of the polarizing plate protective film of the present invention is preferably 15 nm or more and 300 nm or less and more preferably 30 nm or more and 250 nm or less.

<Polarizer>

Next, the polarizer that the polarizing plate of the present invention comprises will be described.

A polarizer that can be used in the polarizing plate of the present invention is preferably configured of a polyvinyl alcohol (PVA) and a dichromatic molecule; however, as described in JP1999-248937A (JP-H11-248937A), it is also possible to use a polyvinylene-based polarizer obtained by generating a polyene structure by dehydrating and dechlorinating PVA and a polyvinyl chloride and orienting the polyene structure.

In the polarizing plate of the present invention, in a case where the polarizer contains the dye, a method and a timing of adding the dye to the polarizer are not particularly limited, and the dye can be added to the polarizer in any of a stage of forming a polyvinyl alcohol film and a stage of introducing the dichromatic molecule to the polyvinyl alcohol film.

The film thickness of the polarizer before being stretched is not particularly limited, but is preferably 1 μm to 1 mm and particularly preferably 5 to 200 μm from the viewpoint of the stability of holding the film and the uniformity of stretching. In addition, as described in JP2002-236212A, a thin PVA film may be used so that a stress that is generated in the case of stretching the polarizer four to six times in water becomes 10 N or less.

A method for manufacturing the polarizer is not particularly limited, but the polarizer is preferably configured by, for example, turning the PVA into a film and introducing the dichromatic molecule to the film. The PVA film can be manufactured with reference to a method described in Paragraphs [0213] to [0237] of JP2007-086748A, the specification of JP3342516B, JP1997-328593A (JP-H09-328593A), JP2001-302817A, JP2002-144401A, and the like.

<Adhesive Layer>

In the polarizing plate of the present invention, an adhesive that adheres the polarizer and the polarizing plate protective film is not particularly limited as long as the adhesive is capable of adhering both, and examples thereof include polyvinyl alcohol-based adhesives such as a polyvinyl alcohol and a polyvinyl butyral, vinyl-based latex such as butyl acrylate, and the like. In addition, ultraviolet-curable adhesives and the like can also be exemplified. A particularly preferred adhesive is an aqueous solution of a fully-saponified polyvinyl alcohol or an ultraviolet-curable adhesive.

Furthermore, an attachment method described in JP2015-011094A can also be preferably used as a method for attaching the polarizing plate protective film and the polarizer. That is, a corona treatment is carried out on a surface of the polarizing plate protective film, then, an active energy ray-curable adhesive composition is applied to the surface, attached to the polarizer, and radiated with ultraviolet rays, and a resin is cured and then dried.

In the polarizing plate of the present invention, in a case where the adhesive layer contains the dye, a method and a timing of adding the dye to the adhesive layer are not particularly limited, and the dye can be added to an application liquid when the adhesive is applied.

The thickness of the adhesive layer is not particularly limited, but is, for example, preferably 1 to 50 μm and more preferably 5 to 30 μm.

<Optical Characteristics and the Like of Polarizing Plate>

The optical characteristics and the like of the polarizing plate of the present invention will be described.

1. Degree of Polarization

The degree of polarization of the polarizing plate of the present invention is preferably 99.950% or more, more preferably 99.970% or more, and most preferably 99.990% or more.

In the present invention, the degree of polarization of the polarizing plate is computed from an orthogonal transmittance and a parallel transmittance measured at a wavelength range of 380 to 780 nm using an automatic polarizing film measurement instrument: VAP-7070 (manufactured by JASCO Corporation) using the following equation.

Degree of polarization(%)=[(parallel transmittance-orthogonal transmittance)/(orthogonal transmittance+parallel transmittance)]^{1/2}×100

The degree of polarization can be measured as described below. Two samples (5 cm×5 cm) are produced by attaching the polarizing plate on glass through a pressure-sensitive adhesive. At this time, the polarizing plate protective film is attached so as to be on a side opposite to the glass (an interface with the air). The orthogonal transmittance and the parallel transmittance are measured by setting the glass side of these samples toward a light source. The orthogonal transmittance and the parallel transmittance of the two samples are measured, and the average values are regarded as the orthogonal transmittance and the parallel transmittance respectively.

(10% Value Width in Main Absorption Wavelength Range)

In the present invention, in the main absorption wavelength range exhibited by the dye, in a case where two wavelengths at which an absorbance that is 10% of the absorbance at which the maximum absorption appears appears are converted to wave numbers, there are two aspects, that is, an aspect in which the difference between the absorbances (referred to as the 10% value width) is 2,200 cm⁻¹ or less and an aspect in which the difference exceeds 2,200 cm⁻¹.

In the present invention, in a case where the polarizing plate contains two or more dyes, the 10% value width reaching 2,200 cm⁻¹ or less means that the 10% value width of at least one dye reaches 2,200 cm⁻¹ or less.

In the present invention, the absorbance at which the maximum absorption appears is an absorbance of an absorption peak and is regarded as a value obtained by subtracting a measurement value of a flat range (generally, determined by preparing a polarizing plate not containing the dye for comparison) not derived from the absorption of the dye from a measurement value of the absorbance at a wavelength at which the maximum absorption appears. In addition, two wave numbers at which the absorbance that is 10% of the absorbance at which the maximum absorption appears (is imparted) are two wave numbers at which the absorbance that is 10% of the absorbance at which the maximum absorption appears appears and which are present on the short wavelength side and the long wavelength side of the wave number at which the maximum absorption appears. That is, regarding the 10% value width, in a wave number-absorbance graph obtained from the polarizing plate that is a measurement subject, the maximum absorbance is obtained by subtracting the above-described blank, and points at which the above-described graph curve intersects (reaches) the absorbances that are 10% of the maximum absorbance are regarded as the two wave numbers. The 10% value width refers to a difference (absolute value) between the two wave numbers at which the 10% absorbance appears which are determined as described above. The wave numbers at which the 10% absorbance appears may be in the main absorption wavelength range or outside the main absorption wavelength range.

The 10% value width can be computed using the above-described method on the basis of an absorbance chart (data) obtained by measuring the absorbance every nanometer in a wavelength range of 400 to 800 nm using a spectral photometer for the polarizing plate (a configurational layer containing the dye) of the present invention and a polarizing plate that is identical to the polarizing plate of the present invention except for the fact that the dye is not contained.

The 10% value width can be adjusted or set using the type of the polymer that serves as a matrix and the combination with the dye. For example, in order to set the 10% value width to 2,200 cm⁻¹ or less, it is preferable to use the cycloolefin-based polymer as the matrix with respect to the dyes represented by General Formulae (1) to (5). Meanwhile, in order to set the 10% value width to 2,200 cm⁻¹ or less, it is preferable to use the cellulose acylate as the matrix with respect to the dyes represented by General Formulae (1) to (9) or other dyes.

(Other Characteristics)

Other preferred optical characteristics and the like of the polarizing plate of the present invention are described in [0238] to [0255] of JP2007-086748A, and these characteristics are preferably satisfied.

(Shape and Configuration)

Regarding the shape of the polarizing plate of the present invention, not only a polarizing plate in an aspect of a film piece cut to be small enough to be combined into liquid crystal display devices but also a polarizing plate in an aspect of being produced long by continuous production and wound in a coil shape (for example, an aspect of a roll length of 2,500 m or longer or 3,900 m or longer) are included. In order to use the polarizing plate for large-screen liquid crystal display devices, the width of the polarizing plate is preferably set to 1,470 mm or more.

The polarizing plate of the present invention is configured of the polarizer, the adhesive layer, and the polarizing plate protective film and is also preferably configured by further attaching a separator film to a surface of the polarizing plate.

The separator film is used for the purpose of protecting the polarizing plate at the time of shipping the polarizing plate, at the time of inspecting products, and the like. The separator film is used for the purpose of covering the adhesive layer that is attached to liquid crystal plates and is used on a surface side on which the polarizing plate is attached to liquid crystal plates.

(Functionalization of Polarizing Plate)

The polarizing plate of the present invention is also preferably used as a functionalized polarizing plate complexed with an optical film having functional layers such as an antireflection film (layer) for improving the visibility of displays, a brightness improvement film, a hardcoat layer, a forward scattering layer, an antiglare layer, an antifouling layer, and an antistatic layer. Regarding an antireflection film, the brightness improvement film, other functional optical films, the hardcoat layer, the forward scattering layer, and the antiglare layer for functionalization, there are descriptions in [0257] to [0276] of JP2007-086748A, and it is possible to produce polarizing plates functionalized on the basis of the above description.

<Method For Manufacturing Polarizing Plate>

The polarizing plate of the present invention is manufactured by adhering (laminating) the above-described polarizing plate protective film on at least one surface of the polarizer through the adhesive layer. The polarizing plate of the present invention is preferably produced using a method in which a surface of the polarizing plate protective film is alkali-treated and attached to at least one surface, preferably both surfaces, of a polarizer produced by immersing and stretching a polyvinyl alcohol (PVA) film in an iodine solution using a fully saponified polyvinyl alcohol aqueous solution. In the method for manufacturing the polarizing plate, at least one of the polarizing plate, the adhesive layer, or the polarizing plate protective film or at least one of raw materials forming the polarizing plate, the adhesive layer, and the polarizing plate protective film contains the above-described dye. Therefore, it is possible to manufacture the polarizing plate, furthermore, the polarizing plate protective film and liquid crystal display devices without newly providing a layer containing the dye by adding the dye to a material composition that forms the configurational layers. Therefore, according to the present invention, a layer containing the dye may not be separately provided, and it is possible to make a new coating step unnecessary in the formation of a layer containing the dye.

(Method For Laminating Polarizer and Polarizing Plate Protective Film)

A method for attaching the polarizing plate protective film to the polarizer is preferably attachment in which the transmission axis of the polarizer and the slow axis of the polarizing plate protective film become substantially parallel or orthogonal to each other or form an angle of 45°.

The slow axis can be measured using a variety of well-known methods and can be measured using, for example, a birefringence measurement instrument (KOBRADH, manufactured by Oji Scientific Instruments).

Here, the expression “substantially parallel” refers to the fact that the direction of the main refractive index nx of the polarizing plate protective film and the direction of the transmission axis of the polarizing plate intersect each other at an angular deviation of ±5° or less, and the directions preferably intersect each other at an angle of ±1° or less and more preferably intersect each other at an angle of ±0.5° or less. In a case where the intersection angle is ±1° or less, the performance of the degree of polarization under polarizing plate crossed nicols does not easily degrade, and voids of light are not easily generated, which is preferable.

The expression “the direction of the main refractive index nx and the direction of the transmission axis being orthogonal to each other or forming an angle of 45°” refers to the fact that the intersection angle between the direction of the main refractive index nx and the direction of the transmission axis is strictly orthogonal or 45° with an angular tolerance of ±5°, and the error from the strict angle is preferably in a range of ±1° and more preferably in a range of ±0.5°.

[Liquid Crystal Display Device]

Next, a liquid crystal display device of the present invention will be described.

The liquid crystal display device of the present invention has at least one polarizing plate of the present invention disposed downstream in a light emitting direction of light that is emitted from a backlight unit. The number of the polarizing plates of the present invention that the liquid crystal display device has may be two or more and is preferably one or two.

FIG. 3 is a schematic view showing an example of the liquid crystal display device of the present invention. In FIG. 3, a side of a liquid crystal layer 5 on which a backlight unit B is disposed is referred to as the lower or rear surface side, and a side on which a first polarizing plate 1 is disposed is referred to as the upper or viewer side. A liquid crystal display device 10 has a liquid crystal cell having a first (above the liquid crystal cell) electrode substrate 3 and a second (below the liquid crystal cell) electrode substrate 6 disposed on both surface sides of the liquid crystal layer 5, a first (upper side) polarizing plate 1 and a second (lower side) polarizing plate 8 disposed on both sides of the liquid crystal cell, and the backlight unit B on a rear surface side of the second polarizing plate 8.

A color filter layer may be laminated on the electrode substrate 3 or the electrode substrate 6. Generally, a substrate of the liquid crystal cell has a thickness of 50 μm to 2 mm.

Although not shown in FIG. 3, generally, each of the first polarizing plate 1 and the second polarizing plate 6 has a laminate configuration in which a polarizer is sandwiched by two polarizing plate protective films. In the liquid crystal display device 10 of the present invention, at least one polarizing plate is preferably the polarizing plate of the present invention. At this time, a layer, a film, or a polarizing plate including the above-described dye is preferably disposed on the backlight unit B side. For example, the polarizing plate of the present invention may be used as any of the first polarizing plate 1 and the second polarizing plate 6, but is preferably used as the second polarizing plate 6. In addition, in a case where the polarizing plate of the present invention comprises a polarizing plate protective film containing the dye on one surface of the polarizer, the polarizing plate is disposed so that a polarizing plate protective film not containing the dye is on the backlight unit B side. Furthermore, in a case where the polarizing plate of the present invention comprises the polarizing plate protective films on both surfaces of the polarizer, the dye may be contained in any of the polarizing plate protective films, but the dye is preferably contained in a polarizing plate protective film that is located farther from the backlight unit B in a case where the polarizing plate is disposed in the liquid crystal display device 10.

The backlight unit that the liquid crystal display device of the present invention comprises is not particularly limited as long as the backlight unit is capable of supplying light to a liquid crystal panel made up of the liquid crystal cell, the first polarizing plate 1, and the second polarizing plate 8, and an ordinary configuration can be employed. Generally, the backlight unit includes a light source and a light guide plate that is configured to guide light emitted from the light source to the liquid crystal panel. As the light guide plate, an ordinary light guide plate can be used without any particular limitations and thus will not be described.

As the light source in the backlight unit, a light emitting diode (LED), a laser diode, an electroluminescent element, and the like can be used; however, from the viewpoint of brightness, a light emitting diode is preferred. Particularly, a method in which a blue LED or a near-ultraviolet LED is used as a light emitting element and light emitted from the light emitting element is converted to different wavelengths using a fluorescent body is preferred from the viewpoint of improving color reproducibility in the combination with the polarizing plate of the present invention. Particularly, 1) a combination of a blue LED and a yellow fluorescent body, 2) a combination of a blue LED, a green fluorescent body, and a red fluorescent body, and 3) a combination of a near-ultraviolet LED, a green fluorescent body, a red fluorescent body, and a blue fluorescent body can be preferably used. Meanwhile, the fluorescent body may be combined into the LED light source and may be installed at a location other than the light source as a wavelength conversion sheet.

(Yellow Fluorescent Body)

The yellow fluorescent body absorbs some of light emitted from the blue LED and emits yellow light having a light emission peak in a wavelength range of 510 to 600 nm. As such a yellow fluorescent body, for example, Y₃Al₅O₁₂: Ce³⁺, Tb₃Al₅O₁₂: Ce³⁺, (Y_{0.8}Gd_{0.2})₃Al₅O₁₂: Ce, BaY₂SiAl₄O₁₂: Ce³⁺, M₂SiO₄: Eu²⁺ (M represents at least one selected from Ca, Sr, Ba, Mg, and Zn), Lu₃Al₅O₁₂: Ce³⁺ (LAG), and the like can be used. In addition, a red fluorescent body such as CASN or SCASN may be added as necessary.

(Green Fluorescent Body)

A green fluorescent body 43 absorbs some of light emitted from the blue LED and emits green light having a light emission peak in a wavelength range of 500 to 595 nm. Examples of such a green fluorescent body include Y₃Al₅O₁₂: Ce³⁺, Tb₃Al₅O₁₂: Ce³⁺, BaY₂SiAl₄O₁₂: Ce³⁺, Ca₃Sc₂Si₃O₁₂: Ce³⁺, (Ba, Sr)₂SiO₄: Eu²⁺, CaSc₂O₄: Ce³⁺, Ba₃Si₆O₁₂N₂: Eu²⁺, β-SiAlON: Eu²⁺, SrGa₂S₄: Eu²⁺, LaSiN: Ce³⁺, CaSi₂O₂N₂: Eu²⁺, Lu₃Al₅O₁₂: Ce³⁺ (LAG) or SrSi₂O₂N₂: Eu²⁺, and the like.

(Red Fluorescent Body)

The red fluorescent body absorbs at least one of some of light emitted from the blue LED and some of light emitted from the green fluorescent body and emits red light having a light emission peak in a wavelength range of 600 to 690 nm. Examples of such a red fluorescent body include Ca-α-SiAlON: Eu²⁺, CaAlSiN₃: Eu²⁺, (Sr, Ca)AlSiN₃: Eu2+, Sr₂Si₅N₈: Eu²⁺, Sr₂(Si, Al)₅(N, O)₈: Eu²⁺, CaS: Eu²⁺, La₂O₂S: Eu³⁺, K₂SiF₆:Mn⁴⁺, and the like.

(Blue Fluorescent Body)

As the blue fluorescent body, a fluorescent body having a peak wavelength of light emission in a range of 430 to 460 nm is used, and, particularly, europium-activated chlorophosphate fluorescent body having a composition represented by Formula (1) is preferably used.

(Sr_{1-x-y-z}BaₓCa_{y}Eu_{z})₅(PO₄)₃·Cl Formula (1)

In the formula, x, y, and z are numbers satisfying 0≤x<0.5, 0≤y<0.1, and 0.005<z<0.1.

The blue fluorescent body having the composition represented by Formula (1) is capable of obtaining blue light having an excellent light emission efficiency.

(Quantum Dot)

A variety of (green, red, and blue) fluorescent bodies described above may be quantum dots. The quantum dot is a particle having a long diameter of approximately 1 to 100 nm and has a discrete energy level. The energy state of the quantum dot depends on the size of the quantum dot, and thus it becomes possible to freely select the light emission wavelength by changing the size. The quantum dot is, for example, a compound of an element in Group XII and an element in Group XVI, a compound of an element in Group XIII and an element in Group XVI, or a compound of an element in Group XIV and an element in Group XVI, and examples thereof include CdSe, CdTe, ZnS, CdS, InP, PbS, PbSe, CdHgTe, and the like. As a quantum nanomaterial, a quantum rod or the like as well as the quantum dot can be used.

As the liquid crystal display device 10, there are an image direct view-type liquid crystal display device, an image projection-type liquid crystal display device, and an optical modulation-type liquid crystal display device. The present invention is effective for active matrix liquid crystal display devices for which a three-terminal or two-terminal semiconductor element such as a thin film transistor (TFT) or a metal insulator metal (MIM) is used. It is needless to say that the present invention is also effective for passive matrix liquid crystal display devices represented by a super twisted nematic (STN) mode called time-sharing driving.

A liquid crystal display device of an in-plane switching (IPS) mode described in Paragraphs 128 to 136 of JP2010-102296A is preferred as the liquid crystal display device of the present invention.

### EXAMPLES

Hereinafter, the present invention will be more specifically described using examples.

Materials, reagents, amounts and proportions of materials, operations, and the like described in the examples can be appropriately modified within the scope of the gist of the present invention. Therefore, the scope of the present invention is not limited by the following specific examples.

### Example 101

In Example 101, a polarizing plate containing the dye A and/or the dye B was produced, and characteristics thereof were evaluated.

1. Synthesis of Cellulose Acetate

A cellulose acetate having a degree of acetyl substitution of 2.87 and a degree of polymerization of 370 was synthesized as described below.

Sulfuric acid (7.8 parts by mass with respect to 100 parts by mass of cellulose) was added as a catalyst to cellulose, acetic acid that served as a raw material of an acyl substituent was added thereto, and an acylation reaction was carried out at 40° C. After the acylation, aging was carried out at 40° C. Furthermore, a low-molecular-weight component in this cellulose acetate was cleaned with acetone and removed. The above-described cellulose acetate was synthesized as described above.

2. Preparation of Dope 101 For Air-Side Surface Layer

The following matting agent solution 2 (1.3 parts by mass) and the following cellulose acylate solution 1 (98.7 parts by mass) were mixed together using an inline mixer, thereby preparing a dope 101 liquid for an air-side surface layer.

<2-1: Preparation of Cellulose Acylate Solution 1>

Individual components were injected into a mixing tank in a composition shown below and stirred to be dissolved, thereby preparing a cellulose acylate solution 1.

Composition of cellulose acylate solution 1

| | |
|---|---|
| Cellulose acetate having a degree of acetyl | 100.0 parts by mass |
| substitution of 2.87 and a degree of | |
| polymerization of 370 | |
| Sucrose benzoate (degree of benzoyl | 6.0 parts by mass |
| substitution: 5.5) | |
| Sucrose acetate isobutyrate manufactured | 4.0 parts by mass |
| by Sigma-Aldrich | |
| Methylene chloride (first solvent) | 353.9 parts by mass |
| Methanol (second solvent) | 89.6 parts by mass |
| n-Butanol (third solvent) | 4.5 parts by mass |

<2-2: Preparation of Matting Agent Solution 2>

Individual components were injected into a disperser in a composition shown below and stirred to be dissolved, thereby preparing a matting agent solution 2.

Composition of matting agent solution 2

| | |
|---|---|
| Silica particles having an average particle size of | 2.0 parts by mass |
| 20 nm (AEROSIL R972, manufactured by Nippon | |
| Aerosil Co., Ltd.) | |
| Methylene chloride (first solvent) | 69.3 parts by mass |
| Methanol (second solvent) | 17.5 parts by mass |
| n-Butanol (third solvent) | 0.9 parts by mass |
| Cellulose acylate solution 1 | 0.9 parts by mass |

3. Preparation of Dope 102 For Base Layer (Cellulose Acylate Solution 3)

Individual components were injected into a mixing tank in a composition shown below and stirred to be dissolved, thereby preparing a dope 102 for a base layer.

Composition of dope 102 for base layer

| | |
|---|---|
| Cellulose acetate having a degree of acetyl | 100.0 parts by mass |
| substitution of 2.87 and a degree of | |
| polymerization of 370 | |
| Sucrose benzoate (degree of benzoyl | 6.0 parts by mass |
| substitution: 5.5) | |
| Sucrose acetate isobutyrate manufactured | 4.0 parts by mass |
| by Sigma-Aldrich | |
| Ultraviolet absorber C | 2.0 parts by mass |
| Dye A (FDB-007) | 0.033 parts by mass |
| Dye B (FDG-006) | 0.33 parts by mass |
| Methylene chloride (first solvent) | 297.7 parts by mass |
| Methanol (second solvent) | 75.4 parts by mass |
| n-Butanol (third solvent) | 3.8 parts by mass |

The dye A (FDB-007) is a merocyanine-based dye, and the main absorption wavelength range is present in 480 to 510 nm.

The dye B (FDG-006) is a tetraaza porphyrin-based dye, and the main absorption wavelength range is present in 580 to 610 nm.

As the dyes A and B, commercially available products manufactured by Yamada Chemical Co., Ltd. were used.

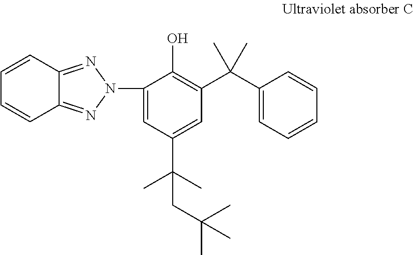 [SMILES: CC(C)(C)CC(C)(C)c1cc(-n2nc3ccccc3n2)c(O)c(C(C)(C)c2ccccc2)c1]

4. Preparation of Dope 103 For Support-Side Surface Layer

The matting agent solution 2 (1.3 parts by mass) and the cellulose acylate solution 1 (99.3 parts by mass), which were produced for the dope 101 for an air-side surface layer, were mixed together using an inline mixer, thereby preparing a dope 103 for a support-side surface layer.

5. Production of Polarizing Plate Protective Film

FIG. 4 is a view showing a method for manufacturing a polarizing plate protective film having a three-layer structure using a drum casting device. In FIG. 4, a reference 89 indicates a casting die, and a reference 70 indicates a cast film obtained by casting a dope.

The drum casting device shown in FIG. 4 was used, the dope 103 for a support-side surface layer, the dope 102 for a base layer, and the dope 101 for an air-side surface layer were caused to be located in references 122, 120, and 121 in FIG. 4, and three layers were uniformly cast at the same time from casting openings provided in the casting die 89 to a stainless steel casting support 85 (the temperature of the support: −9° C.). The layers were peeled off in a state in which the amounts of residual solvents in the dopes for the respective layers were approximately 70% by mass, both ends of a film in the width direction were fixed using a pin tenter, and the film was stretched 1.28 times in the width direction and dried in a state in which the amounts of the residual solvents were 3% to 5% by mass. After that, the film was transported between rolls in a thermal treatment device to be further dried, thereby obtaining a polarizing plate protective film 101. The thickness of the obtained polarizing plate protective film 101 was 60 μm (the air-side surface layer (121a in FIG. 4): 3 μm, the base layer (120a in FIG. 3): 54 μm, and the support-side surface layer (122a in FIG. 3): 3 μm), and the width was 1,480 mm.

6. Production of Cellulose Acylate Film Not Containing Dye (Polarizing Plate Protective Film) <1-1: Preparation of Cellulose Acylate Film 001>

(Preparation of Core Layer Dope Solution 001A)

Individual components were injected into a mixing tank in a composition shown below and stirred to be dissolved, thereby preparing a core layer dope solution 001A.

Composition of core layer dope solution 001A

| | |
|---|---|
| Cellulose acetate having a degree | 100 parts by mass |
| of acetyl substitution of 2.88 | |
| Ester oligomer A | 12 parts by mass |
| Methylene chloride (first solvent) | 430 parts by mass |
| Methanol (second solvent) | 64 parts by mass |

Composition of ester oligomer A

| | |
|---|---|
| 1,2-CHA; 1,2-cyclohexyldicarboxylate | 50 mol % |
| Ethylene glycol | 50 mol % |

In addition, the number-average molecular weight of the ester oligomer A is 750.

(Preparation of Skin Layer Dope Solution)

The following matting agent solution (10 parts by mass) was added to the core layer dope solution 001A (90 parts by mass), thereby preparing a skin layer dope solution.

Composition of matting agent solution

| | |
|---|---|
| Silica particles having an average particle size of | 2 parts by mass |
| 20 nm (AEROSIL R972, manufactured by Nippon | |
| Aerosil Co., Ltd.) | |
| Methylene chloride (first solvent) | 76 parts by mass |
| Methanol (second solvent) | 11 parts by mass |
| Core layer dope solution 001A | 1 part by mass |

(Casting)

Casting was carried out in a band caster using the dope solution prepared above.

A core layer dope solution 301A and a skin layer dope solution containing a matting agent were caused to be located respectively in the reference 120 and the references 122 and 121 in FIG. 4, and co-casting was carried out. Here, the core layer was made to be thickest by adjusting the amounts of the respective dopes cast, and a cast film was formed by co-casting multiple layers at the same time so that the core layer reached 21 μm and the skin layers reached 2 μm respectively in terms of the consequent film thickness of the film after drying.

The layers were peeled off in a state in which the content ratio of the solvent was approximately 20% by mass, both ends of the film in the width direction were fixed using a tenter clip, and the film was stretched 1.1 times in the width direction and dried. After that, the film was transported between rolls in a thermal treatment device to be further dried, thereby producing a cellulose acylate film (polarizing plate protective film) 001.

7. Saponification Treatment of Polarizing Plate Protective Film

The produced polarizing plate protective film 101 was immersed in 2.3 mol/L of a sodium hydroxide aqueous solution at 55° C. for three minutes. The polarizing plate protective film was cleaned in a water washing bath at room temperature (25° C.) and neutralized using 0.05 mol/L of sulfuric acid at 30° C. Again, the polarizing plate protective film was cleaned in a water washing bath at room temperature and, furthermore, dried using hot air at 100° C. A saponification treatment was carried out on the surface of the polarizing plate protective film 101 as described above.

On the polarizing plate protective film 001 as well, a saponification treatment was carried out in the same manner.

8. Production of Polarizer

An 80 μm-thick polyvinyl alcohol (PVA) film was immersed in an iodine aqueous solution having an iodine concentration of 0.05% by mass at 30° C. for 60 seconds to be dyed, subsequently, vertically stretched five times the original length while immersed in a borate aqueous solution having a borate concentration of 4% by mass for 60 seconds, and then dried at 50° C. for four minutes, thereby obtaining a 19 μm-thick polarizer.

9. Manufacturing of Polarizing Plate

The saponified polarizing plate protective film 101 was attached to a single side of the polarizer using a polyvinyl alcohol-based adhesive (containing no dyes), and, furthermore, the polarizing plate protective film 001 was attached to a surface opposite to the surface to which the polarizing plate protective film 101 had been attached. At this time, polarizing plate protective films 101 and 001 and the polarizing plate protective film 001 were disposed so that the respective transmission axes of the polarizers and the slow axis of the polarizing plate protective film became parallel to each other and the respective transmission axes of the polarizers and the slow axis of the polarizing plate protective film became perpendicular to each other. A polarizing plate 101 of Example 101 was produced as described above.

10. Manufacturing of Liquid Crystal Display Device

A liquid crystal panel was removed from a commercially available liquid crystal display device U2417H (trade name, manufactured by DELL), a polarizing plate on a backlight side was peeled off, instead, the polarizing plate 101 of the present invention was attached thereto through a pressure-sensitive adhesive. A liquid crystal display device 101 of the present invention was manufactured as described above.

Meanwhile, as a light source of U2417H, a white LED obtained by combining a blue LED, a green fluorescent body, and a red fluorescent body was used.

### Examples 102 to 104 and Comparative Example 201

1. Production of Polarizing Plate Protective Films 101 to 104 and 201

Polarizing plate protective films 101 to 104 and 201 of Examples 102 to 104 and Comparative Example 201 were respectively produced in the same manner as in the production of the polarizing plate protective film 101 except for the fact that, in the production of the polarizing plate protective film 101, the type and amount added of the dye A and the type and amount added of the dye B were changed as shown in Table 1.

A dye (A-1) used in Examples 103 and 104 is a methine-based dye, and a chemical structure thereof will be shown below. The main absorption wavelength range of this dye is present in 480 to 510 nm.

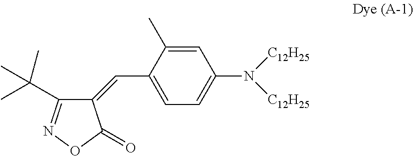

2. Manufacturing of Polarizing Plates

Polarizing plates 101 to 104 and 201 were respectively manufactured in the same manner as in Example 101 except for the fact that, in Example 101, polarizing plate protective films shown in Table 1 were used instead of the polarizing plate protective film 101.

3. Manufacturing of Liquid Crystal Display Devices

Liquid crystal display devices 102 to 104 and 201 were respectively manufactured in the same manner as in the manufacturing of the liquid crystal display device 101 except for the fact that, in the manufacturing of the liquid crystal display device 101, the polarizing plate 101 was changed to the polarizing plates 102 to 104 and 201.

### Evaluation of Polarizing Plate Protective Films, Polarizing Plates, and Liquid Crystal Display Devices

1. Contents of Dye A and Dye B Per Square Meter of Polarizing Plate Protective Film

In the respective polarizing plate protective films produced as described above, the contents (expressed as “Amount added (g/m²)” in Table 1) of the dyes A and B per square meter of the polarizing plate protective film are shown in Table 1.

2. Measurement of Absorbance

Regarding the respective polarizing plate protective films 101 to 104 produced as described above, the absorbance at a wavelength range of 200 to 700 nm was measured using a spectral photometer UV-3150 (trade name, manufactured by Shimadzu Corporation). The absorbance at wavelengths of 480 nm and 580 nm are shown in Table 1.

3. Measurement of 10% Value Widths

In the respective polarizing plate protective films produced as described above, the 10% value width of each of the dye A and the dye B in the polymer was obtained in the same manner as that of a polarizing plate protective film 801 described below. The results are described below.

Polarizing plate protective film 101: 3,880 cm⁻¹ for the dye A and 3,820 cm⁻¹ for the dye B

Polarizing plate protective film 102: 3,820 cm⁻¹ for the dye B

Polarizing plate protective film 103: 5,180 cm⁻¹ for the dye A and 3,820 cm⁻¹ for the dye B

Polarizing plate protective film 104: 5,180 cm⁻¹ for the dye A and 3,820 cm⁻¹ for the dye B

4. Evaluation of Color Reproduction Ranges

A red color, a green color, and a blue color were displayed on the full screen of the produced liquid crystal display device, and the chromaticity of the respective colors was measured using a spectral radiometer: SR-UL2 (trade name, manufactured by Topcon Technohouse Corporation). The area of a portion in which a triangle made by connecting the chromaticity points of the measured red color, green color, and blue color on an xy color diagram of the CIE color system and a triangle made by connecting the three primary color points of the DCI-P3 standard overlapped with each other was obtained, and the area was divided by the area of the triangle made by connecting the three primary color points of the DCI-P3 standard, thereby computing a cover percentage (%) with respect to the DCI-P3 standard. The results are shown in Table 1.

Meanwhile, in the xy color diagram of the CIE color system, the three primary color points of the DCI-P3 standard are as described below respectively.
Red: x=0.680, y=0.320
Green: x=0.265, y=0.690
Blue: x=0.150, y=0.060

TABLE 1

| | | Dye A | | Dye B | | Film absorbance | | DCI-P3 cover |
|---|---|---|---|---|---|---|---|---|
| | | | Amount added | | Amount added | Wavelength | Wavelength | percentage |
| | | Type | (g/m²) | Type | (g/m²) | 480 nm | 580 nm | (%) |
| Example 101 | Polarizing plate | FDB-007 | 0.023 | FDG-006 | 0.234 | 0.425 | 1.514 | 86.9 |
| | protective film 101 | | | | | | | |
| Example 102 | Polarizing plate | — | — | FDG-006 | 0.234 | 0.141 | 1.514 | 80.5 |
| | protective film 102 | | | | | | | |
| Example 103 | Polarizing plate | Dye (A-1) | 0.055 | FDG-006 | 0.234 | 0.653 | 1.514 | 89.0 |
| | protective film 103 | | | | | | | |
| Example 104 | Polarizing plate | Dye (A-1) | 0.110 | FDG-006 | 0.234 | 1.164 | 1.515 | 86.3 |
| | protective film 104 | | | | | | | |
| Comparative | Polarizing plate | — | — | — | — | — | — | 76.7 |
| Example 201 | protective film 201 | | | | | | | |

It is found from the results of Table 1 that all of the polarizing plates 101 to 104 of the present invention increased in the cover percentage with respect to the DCI-P3 standard more than the polarizing plate 201 of the comparative example comprising the polarizing plate protective film containing no dyes and exhibited an effect of extending the color reproduction ranges of the backlight light.

### Evaluation of Reliability (Weather Resistance) During Continuous Lighting of Liquid Crystal Display Device

1. Comparative Example 401

The present example is a comparative experimental example corresponding to a cover-up coating layer in Example 1 of JP2016-090998A, and this comparative experimental example is an example showing that, in a case where a liquid crystal display device is lighted for a long period of time, the image quality degrades.

GS1000 (trade name) manufactured by Soken Chemical & Engineering Co., Ltd. (35 parts by mass) as an acrylic binder polymer, methyl ethyl ketone (MEK) (50 parts by mass) as a solvent, and MX-500 (trade name) manufactured by Soken Chemical & Engineering Co., Ltd. (15 parts by mass) as beads were mixed together, and then FDB-007 manufactured by Yamada Chemical Co., Ltd. and FDG-006 manufactured by Yamada Chemical Co., Ltd. were added to the mixture as dyes in amounts of 0.71 parts by mass and 7.12 parts by mass respectively with respect to 100 parts by mass of the mixture, thereby manufacturing a dye-containing coating composition. The dye-containing coating composition was applied to one surface of a diffusion film (trade name: LIGHT-UP SXE100, manufactured by Kimoto Co., Ltd.) using a Mayer bar, dried, and cured, thereby forming a dye-containing cover-up coating layer in a thickness of 5 μm.

The diffusion film obtained above was used as an upper diffusion plate and introduced to a commercially available liquid crystal display device (trade name: U2417H, manufactured by DELL) so that the cover-up coating layer faces a horizontal prism sheet, thereby manufacturing a liquid crystal display device 401 of a comparative example (refer to FIG. 3A of JP2016-090998A).

2. Example 301

A backlight-side polarizing plate in the above-described commercially available liquid crystal display device was peeled off, and, instead, the polarizing plate 101 produced in Example 101 was attached through a pressure-sensitive adhesive. A liquid crystal display device 301 of the present invention was produced in this manner.

As a result of continuously lighting the liquid crystal display device 301 of the present invention and the liquid crystal display device 401 produced as described above and confirming a change in the image quality, it was found that the liquid crystal display device 301 of the present invention less decreased in the color saturation of red and green than the liquid crystal display device 401 of the comparative example and was preferable.

### Reference Example 501, Example 601, and Comparative Example 701

1. Production of Dye-Containing Film 001A

A dye-containing film (also referred to as a pigment filter) 001A was produced as described below.

<Synthesis of Cycloolefin-Based Polymer A>

8-Methoxycarbonyl-8-methyltetracyclo[4.4.0.1^{2,5}.1^{7,10}]-3-dodecene (72.5 parts by mass), dicyclopentadiene (27.5 parts by mass), 1-hexene (5.6 parts by mass) as molecular weight adjusters, and toluene (200 parts by mass) were prepared in a nitrogen-substituted reaction container and heated to 80° C. A toluene solution of triethylaluminum (0.6 mol/L) (0.18 ml) and a toluene solution (0.025 mol/L) of a methanol-modified WCl₆ (0.58 ml) were added thereto, and the components were reacted at 80° C. for three hours, thereby obtaining a polymer. Next, the obtained ring-opening copolymer solution was put into an autoclave, and toluene (200 parts by mass) was further added thereto. RuHCl(CO)[P(C₆H₅)]₃ that was a hydrogenated catalyst was added thereto in an amount of 2,500 ppm with respect to the amount of the monomers prepared, the hydrogen gas pressure was set to 9 to 10 MPa, and a reaction was carried out for three hours at 160° C. to 165° C. After the end of the reaction, the polymer was precipitated in a large amount of a methanol solution, thereby obtaining a hydrogen-added substance (cycloolefin-based polymer A). The obtained hydrogen-added substance of the ring-opening polymer had a weight-average molecular weight (Mw) of 119×10³ and a molecular weight distribution (Mw/Mn) of 3.1.

<Fine Particle Dispersion Liquid>

| | |
|---|---|
| Fine particles (AEROSIL R812, manufactured | 11 parts by mass |
| by Nippon Aerosil Co., Ltd.) | |
| Ethanol | 89 parts by mass |

The above-described components were stirred and mixed together in a dissolver for 50 minutes and then dispersed using a Manton-Gaulin homogenizer, thereby preparing a fine particle dispersion liquid.

<Fine Particle-Added Liquid>

| | |
|---|---|
| Methylene chloride | 99 parts by mass |
| Cycloolefin-based polymer A | 4 parts by mass |
| Fine particle dispersion liquid | 11 parts by mass |

The cycloolefin-based polymer A was added to a dissolution tank into which methylene chloride was put and heated to be fully dissolved, the fine particle dispersion liquid was slowly added thereto under sufficient stirring, and the components were dispersed using an attritor. This dispersion was filtered with a FINE MET NF manufactured by Nippon Seisen Co., Ltd., thereby preparing a fine particle-added liquid.

<Main Dope Liquid>

A main dope liquid having the following composition was prepared using the cycloolefin-based polymer A.

<Composition of Main Dope Liquid>

| | |
|---|---|
| Methylene chloride | 67.2 parts by mass |
| Methanol | 2.8 parts by mass |
| Cycloolefin-based polymer A | 30 parts by mass |
| Dye B: PD-311F manufactured | 0.0088 parts by mass |
| by Yamamoto Chemicals Inc. | |

Here, the dye B: PD-311F is a tetraaza porphyrin-based dye, and the main absorption wavelength range is present in 580 to 610 nm.

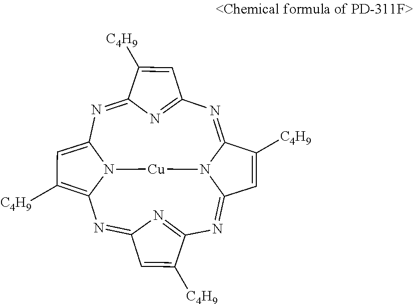

First, methylene chloride and methanol were added to a pressurization and dissolution tank. The cycloolefin-based polymer A was injected into the pressurization and dissolution tank into which a solvent had been put under stirring. The components were heated and fully dissolved under stirring, furthermore, the dye B (PD-311F) was added thereto and dissolved, thereby preparing a main dope liquid.

The fine particle-added liquid (2 parts by mass) was added to the main dope liquid (100 parts by mass), the components were sufficiently mixed together using an inline mixer (Toray static in-tube mixer Hi-Mixer, SWJ) and then uniformly cast on a 2 m-wide stainless steel support using a belt casting device.

From the obtained web (film), the solvent was evaporated until the amount of the residual solvent reached 110% by mass, and the web was peeled off from the stainless steel band support. After the peeling, the web was stretched by applying tension thereto so that the vertical stretch ratio reached 2%.

Next, the film was dried until the amount of the residual solvent reached less than 1% by mass and then further stretched 35% at 165° C. in a direction orthogonal to a film transportation direction using a tenter.

Meanwhile, the amount of the residual solvent was obtained according to the following equation.

Amount of residual solvent (% by mass)={(M−N)/N}×100

Here, M represents the mass of the web at a random point in time, and N represents the mass of the web, M of which has been measured, after being dried at 120° C. for two hours.

As a result, a dye-containing film 001A which had a width of 1.5 m, a film thickness of 35 μm, and Rth of 121 nm and had a 1 cm-wide and 8 μm-high knurling at an end portion was produced.

In the obtained dye-containing film 001A, the content of the dye B: PD-311F was 0.029% by mass of the polymer configuring the dye-containing film 001A and 0.011 g per square meter of the polarizing plate protective film.

For the dye-containing film 001A, the 10% value width in the polymer of the dye B was obtained in the same manner as in the polarizing plate protective film 101. As a result, the 10% value width of the dye B was 2,300 cm⁻¹.

2. Production of Polarizing Plate Protective Film 501

A polarizing plate protective film 501 was produced in the same manner as the dye-containing film 001A except for the fact that, in the production of the dye-containing film 001A, the dye B was not added.

(Reference Example 501: Production of Pressure-Sensitive Adhesive-Attached Polarizing Plate)

1. Production of Polarizer

A 75 μm-thick polyvinyl alcohol film made of a polyvinyl alcohol having an average degree of polymerization of 2,400 and a degree of saponification of 99.9 mol % or more was immersed in pure water at 30° C. and then immersed in an aqueous solution of iodine, potassium iodide, and water in a mass ratio of 0.02/2/100 at 30° C. After that, the polyvinyl alcohol film was immersed in an aqueous solution of potassium iodide, boric acid, and water in a mass ratio of 12/5/100 at 56.5° C.

Subsequently, the polyvinyl alcohol film was cleaned with pure water at 8° C. and dried at 65° C., thereby obtaining a polarizer having iodine adsorbed to and oriented in the polyvinyl alcohol film. The polarizer was stretched mainly in steps of iodine dyeing and a boric acid treatment, and the total stretch ratio was 5.3 times.

2. Preparation of Water-Based Adhesive Composition

An acetoacetyl group-modified polyvinyl alcohol (GOHSEFIMER Z-200 (trade name) manufactured by The Nippon Synthetic Chemical Industry, the viscosity of 4% aqueous solution: 12.4 mPa·sec, and the degree of saponification: 99.1 mol %) was dissolved in pure water, thereby preparing an aqueous solution having a concentration of 10%. This acetoacetyl group-modified polyvinyl alcohol aqueous solution and sodium glyoxylate that serves as a crosslinking agent were mixed together so that the mass ratio of the solid content between the acetoacetyl group-modified polyvinyl alcohol aqueous solution and sodium glyoxylate reached 1:0.1, and, furthermore, the mixture was diluted with pure water so that the proportion of the acetoacetyl group-modified polyvinyl alcohol reached 2.5 parts with respect to 100 parts of water, thereby preparing a water-based adhesive composition.

3. Attachment

On an outer layer side of the polarizing plate protective film 501, a corona discharge irradiation was carried out under a condition of 400 W·min/m² using VE1A-A manufactured by VETAPHONE, and the polarizing plate protective film was attached to a single surface of the polarizer using the water-based adhesive composition produced above. A saponified triacetyl cellulose film was attached to the other surface of the polarizer, thereby producing a polarizing plate 501.

The saponified triacetyl cellulose film was produced as described below. FUJITAC TD80UL (manufactured by Fujifilm Corporation) was immersed in a 4.5 mol/L of sodium hydroxide aqueous solution (saponified liquid) having a temperature adjusted to 37° C. for one minute, then, the film was washed with water, and then the film was immersed in a 0.05 mol/L of sulfuric acid aqueous solution for 30 seconds and, furthermore, passed through a water washing bath. In addition, the film was repeatedly drained three times using an air knife and, after the water dropped, was held in a drying zone at 70° C. for 15 seconds to be dried, thereby producing a saponified triacetyl cellulose film.

4. Preparation of Pressure-Sensitive Adhesive Coating Liquid 501

Components shown below were mixed together in a composition shown below, thereby preparing a pressure-sensitive adhesive coating liquid 501.

Composition of pressure-sensitive adhesive coating liquid 501

| | |
|---|---|
| SK-DYNE SF-2147 manufactured by Soken | 100.0 parts by mass |
| Chemical & Engineering Co., Ltd. | |
| Isocyanate-based crosslinking agent (TD-75: | 0.04 parts by mass |
| trimethylolpropane adduct of tolylene diisocyanate: | |
| manufactured by Soken Chemical & Engineering | |
| Co., Ltd.) | |
| Dye B: PD-311F manufactured by Yamamoto | 0.07 parts by mass |
| Chemicals Inc. | |

5. Production of Pressure-Sensitive Adhesive Layer

The pressure-sensitive adhesive coating liquid 501 was applied onto a surface of the polarizing plate protective film 501 in the polarizing plate 501 produced above using a die coating method, furthermore, a 100 μm-thick polyethylene terephthalate film was placed thereon, and then the pressure-sensitive adhesive coating liquid was dried at 120° C. for three minutes, thereby producing a 21 μm-thick dye-containing pressure-sensitive adhesive layer.

Next, the polyethylene terephthalate film was peeled off, and the surface to which the polyethylene terephthalate film had been attached was attached to a glass plate, thereby producing a sample for light resistance testing 501.

This sample for light resistance testing 501 had a configuration in which a polarizing plate (the polarizing plate protective film 501 containing no dyes/a polarizer/a polarizing plate protective film containing no dyes) was laminated on the glass plate through the dye-containing pressure-sensitive adhesive layer.

### Example 601

### Production of Pressure-Sensitive Adhesive-Attached Polarizing Plate

A pressure-sensitive adhesive-attached polarizing plate 601 of the present invention and a sample for light resistance testing 601 were produced in the same manner as in the production of the pressure-sensitive adhesive-attached polarizing plate of Reference Example 501 except for the fact that, in production of the pressure-sensitive adhesive-attached polarizing plate 501, the polarizing plate protective film 501 was changed to the dye-containing film 001A, and, furthermore, the dye B: PD-311F was removed from the pressure-sensitive adhesive coating liquid 501.

This sample for light resistance testing 601 had a configuration in which a polarizing plate (the dye-containing film 001A/a polarizer/a polarizing plate protective film containing no dyes) was laminated on the glass plate through a pressure-sensitive adhesive layer containing no dyes.

### Comparative Example 701

### Production of Sample For Light Resistance Testing 701

A sample for light resistance testing 701 of a comparative Example was produced in the same manner as in the production of the pressure-sensitive adhesive-attached polarizing plate of Reference Example 501 except for the fact that, in production of the pressure-sensitive adhesive-attached polarizing plate 501, the polarizing plate 501 was changed to the dye-containing film 001A, and, furthermore, the dye B: PD-311F was removed from the pressure-sensitive adhesive coating liquid 501.

This sample for light resistance testing 701 had a configuration in which the dye-containing film 001A was laminated on the glass plate through a pressure-sensitive adhesive layer containing no dyes.

<Evaluation of Light Resistance>

Light was made incident on the glass side of the sample for light resistance testing using a spectral photometer UV-3150 manufactured by Shimadzu Corporation, the absorbance of each sample for light resistance testing in a wavelength range of 400 to 800 nm was measured every nanometer, the maximum absorption wavelength was obtained, and the difference between the absorbance at the maximum absorption wavelength and the absorbance at a wavelength of 800 nm was defined as the dye absorbance.

Next, each sample for light resistance testing was irradiated with light for 200 hours using a super xenon weather meter SX75 manufactured by Suga Test Instruments Co., Ltd. in an environment of 60° C. and a relative humidity of 50%, then, the absorbance in a wavelength range of 400 to 800 nm was measured every nanometer in the same manner as described above, the dye absorbance after the irradiation with light was obtained, and the absorbance residual percentage was computed using the following equation. The results are shown in Table 2.

Absorbance residual percentage (%)=(absorbance difference after 200-hour irradiation)/(absorbance difference before irradiation)×100

TABLE 2

| | | Pigment- | Content of | |
|---|---|---|---|---|
| | | containing | pigment | Light |
| | Configuration | layer | (mg/m²) | resistance^{a)} |
| | Polarizing | Pressure-sensitive | 46.8 | 80% |
| | plate | adhesive layer | | |
| Example 601 | Polarizing | Polarizing plate | 46.8 | 90% |
| | plate | protective film | | |
| Comparative | Dye-containing | Sole film | 46.8 | 5% |
| Example 701 | film | | | |

a)Absorbance residual percentage after irradiation with 100,000 Lux of xenon for 200 hours

From the results of Table 2, it is found that the samples for light resistance testing 501 and 601 had a higher absorbance residual percentage and more favorable light resistance than the sample for light resistance testing 701 of the comparative example in which the dye-containing film 001A was not combined into the polarizing plate. The sample for light resistance testing 601 of the present invention had a higher absorbance residual percentage than the sample for light resistance testing 501 and was particularly preferred.

### Examples 801 to 805 and Comparative Example 901

In the present examples, polarizing plate protective films were produced, the light resistance was evaluated, then, polarizing plates and liquid crystal display devices were manufactured, and the color reproduction ranges and the brightness were evaluated.

<Production of Polarizing Plate Protective Films>

Polarizing plate protective films 801 to 805 of the present invention and a polarizing plate protective film 901 of a comparative example were produced in the same manner as in the production of the dye-containing film 001A except for the fact that, in the production of the dye-containing film 001A, the type and amount added of the dye were changed as shown in Table 4.

### Example 811

<Production of Polarizing Plate Protective Film 811>

A polarizing plate protective film 811 was produced as described below.

1. Preparation of Cellulose Acylate Film 811A

(Preparation of Core Layer Dope Solution 811A)

Individual components were injected into a mixing tank in a composition shown below and stirred to be dissolved, thereby preparing a core layer dope solution 811A.

Composition of core layer dope solution 811A

| | |
|---|---|
| Cellulose acetate (degree of acetyl | 100 parts by mass |
| substitution: 2.43) | |
| Additive 1 (oligomer 1 described below) | 4 parts by mass |
| Additive 2 (compound P-5 shown below) | 7.5 parts by mass |
| Dye B: The exemplary pigment 3-41 | 0.0168 parts by mass |
| Methylene chloride | 394.0 parts by mass |
| Methanol | 59.0 parts by mass |

—Oligomer 1—

A dicarboxylic acid of terephthalic acid and succinic acid in the following molar ratio and a diol of ethylene glycol and propylene glycol in the following molar ratio were reacted together, and then the terminals were sealed, thereby obtaining an oligomer 1. The respective types and molar ratios (preparation ratios) of the dicarboxylic acid and the diol that were raw materials and the terminal sealing structure and molecular weight of the obtained oligomer 1 are as shown in Table 3.

TABLE 3

| | Dicarboxylic acid unit | | Diol unit | | | |
|---|---|---|---|---|---|---|
| | 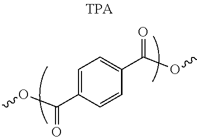 | 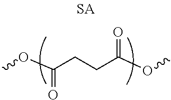 | 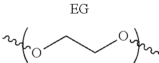 | 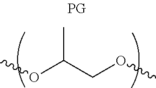 | Terminal unit | Weight- average molecular weight |
| Molar | 70 | 30 | 50 | 50 | —OAc | 1200 |
| ratio | | | | | | |

In the table, TPA represents terephthalic acid, SA represents succinic acid, EG represents ethylene glycol, and PG represents propylene glycol.
Ac represents an acetyl group.
The weight-average molecular weight was measured in terms of polystyrene by gel permeation chromatography.

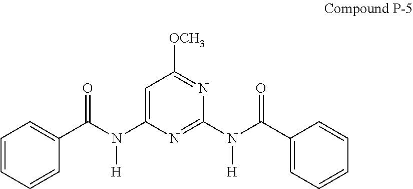 [SMILES: COc1cc(NC(=O)c2ccccc2)nc(NC(=O)c2ccccc2)n1]

2. Preparation of Skin Layer Dope Solution

Individual components were injected into a mixing tank in a composition shown below and stirred to be dissolved, thereby preparing a skin layer dope solution.

Composition of skin layer dope solution

| | |
|---|---|
| Cellulose acetate (degree of acetyl | 100 parts by mass |
| substitution: 2.81) | |
| Dye B: The exemplary pigment 3-41 | 0.016 parts by mass |
| Methylene chloride | 425.0 parts by mass |
| Methanol | 63.0 parts by mass |

3. Adjustment of Matting Agent Solution

Individual components were injected into a disperser in a composition shown below and stirred to be dissolved, thereby preparing a matting agent dispersion liquid M1.

Composition of matting agent dispersion liquid M1

| | |
|---|---|
| Silica particles having an average particle size of | 2.0 parts by mass |
| 20 nm (AEROSIL (registered trademark) R972, | |
| manufactured by Nippon Aerosil Co., Ltd.) | |
| Methylene chloride | 76.1 parts by mass |
| Methanol | 11.4 parts by mass |
| Skin layer dope solution prepared above | 12.6 parts by mass |

4. Preparation of Skin Layer Dope Solution Containing Matting Agent

The matting agent dispersion liquid M1 was mixed into the skin layer dope solution prepared above in a proportion shown below, thereby preparing a skin layer dope solution containing the matting agent.

Preparation of skin layer dope solution

| | |
|---|---|
| Skin layer dope solution | 100.0 parts by mass |
| Matting agent dispersion liquid M1 | 7.1 parts by mass |

5. Casting

Casting was carried out in a band caster using the dope solutions prepared above.

The core layer dope solution 811A and the skin layer dope solution containing the matting agent were caused to be located respectively in the reference 120 and the references 122 and 121 in FIG. 4, and co-casting was carried out. Here, the core layer was made to be thickest by adjusting the amounts of the respective dopes cast, and a cast film was formed by the simultaneous co-casting of multiple layers so that the core layer reached 40 μm and the skin layers reached 2 μm respectively in terms of the consequent film thickness of the film after stretching.

Next, the cast film was peeled off from a band 85, turned into a wet film, and dried in a migration portion and a tenter. Meanwhile, the amount of a residual solvent in the wet film immediately after the peeling of the dopes was approximately 25% by mass. The wet film was sent to a drying chamber, sufficiently dried in an accelerated manner while being coiled around a number of rollers and transported, and cast, thereby obtaining a film.

6. Stretching

The film obtained by casting was gripped with clips and stretched in the horizontal direction under a fixed end uniaxial condition. The stretching temperature was set to 185° C., and the stretch ratio was set to 31%.

7. Moist Heat Treatment

On each film that had been subjected to the stretching treatment, a dew condensation prevention treatment, a moist heat treatment (water vapor contact treatment), and a thermal treatment were sequentially carried out.

In the dew condensation prevention treatment, the film temperature Tf0 was adjusted to 120° C. by striking each film with the dried air.

In the moist heat treatment (water vapor contact treatment), the absolute humidity (the absolute humidity of the moist heat treatment) of a wet gas in a wet gas contact chamber was set to become 250 g/m³. In addition, the dew point of the wet gas was adjusted to become a temperature that was higher than the temperature Tf0 of each film by 10° C. or more. Each film was transported while maintaining a state in which the temperature of each film (the temperature of the moist heat treatment) reached 100° C. for as long as a treatment time (60 seconds) in the above-described manner.

In the thermal treatment, the absolute humidity of a gas in a thermal treatment chamber (the absolute humidity of the thermal treatment) was set to 0 g/m³, and the temperature of each film (the temperature of the thermal treatment) was set to a temperature identical to the temperature of the moist heat treatment and maintained for as long as a treatment time (two minutes). The film surface temperature was obtained by attaching tape-type thermocouple surface temperature sensors (ST series manufactured by Anritsu Meter Co., Ltd.) to three points on the film, and computing the average value of the respective film surface temperatures.

8. Coiling

After that, the film was cooled to room temperature and then coiled. The thicknesses of the respective layers in the cellulose acylate film 811A produced as described above were 40 μm for the core layer and 2 μm for the skin layer.

### Comparative Example 911

<Production of Polarizing Plate Protective Film 911>

A polarizing plate protective film 911 of a comparative example was produced in the same manner as in the production of the polarizing plate protective film 811 except for the fact that, in the production of the polarizing plate protective film 811, the dye was not added.

<Evaluation of Polarizing Plate Protective Films 801 to 805, 811, 901, and 911>

The maximum absorption wavelengths, the 10% value widths, and the light resistance of the respective produced polarizing plate protective films were measured using the following methods, and the results are shown in Table 4.

1. Maximum Absorption Wavelength and 10% Value Width

The absorbances in a wavelength range of 400 nm to 800 nm of the polarizing plate protective films 801 to 805, 811, 901, and 911 were measured every nanometer using a spectral photometer UV-3150 manufactured by Shimadzu Corporation. For the polarizing plate protective films 801 to 805, the absorbance differences between the absorbances at the respective wavelengths and the absorbance of the polarizing plate protective film 901 containing no dyes were computed, and a wavelength at which the absorbance difference was maximized was defined as the maximum absorption wavelength. Furthermore, two wave numbers at which the absorbance difference was 10% of the maximum value of the absorbance difference were read, and the large wave number was represented by v1, and the small wave number was represented by v2. The 10% value width represented by a wave number (cm⁻¹) unit was computed using the following equation.

10% value width (cm⁻¹)=v1−v2

In addition, for the polarizing plate protective film 811 as well, the absorbance difference from the absorbance of the polarizing plate protective film 911 containing no dyes was computed, and the maximum absorption wavelength and the 10% value width were obtained in the same manner.

Meanwhile, for the polarizing plate protective films 804 and 805 including the dye A and the dye B, maximum absorption wavelengths and 10% value widths that respectively corresponded to the dye A and the dye B were obtained.

2. Light Resistance

The respective produced polarizing plate protective films were irradiated with light for 20 hours using a super xenon weather meter SX75 manufactured by Suga Test Instruments Co., Ltd. in an environment of 60° C. and a relative humidity of 50%, then, the absorbance difference at the maximum absorption wavelength was measured, and the absorbance residual percentage was computed using the following equation.

In the present testing, in a case where the absorbance residual percentage is 50% or more, the light resistance can be said to be excellent.

Absorbance residual percentage (%)=(absorbance difference after 20-hour irradiation)/(absorbance difference before irradiation)×100

TABLE 4

| | Polarizing | | | | | | | |
|---|---|---|---|---|---|---|---|---|
| | plate | | Pigment B | | | Pigment A | | |
| | protective | | | a1) | a2) | | a1) | a2) |
| | film | Matrix resin | Type | Content | Content | Type | Content | Content |
| Example 801 | 801 | Cycloolefin-based | 3-41 | 0.0258 | 0.0096 | N/A | N/A | 0 |
| | | polymer A | | | | | | |
| Example 802 | 802 | Cycloolefin-based | 3-8 | 0.0074 | 0.0028 | N/A | N/A | 0 |
| | | polymer A | | | | | | |
| Example 803 | 803 | Cycloolefin-based | 3-9 | 0.0068 | 0.0025 | N/A | N/A | 0 |
| | | polymer A | | | | | | |
| Example 804 | 804 | Cycloolefin-based | 3-41 | 0.0184 | 0.0069 | 7-1 | 0.0308 | 0.0115 |
| | | polymer A | | | | | | |
| Example 805 | 805 | Cycloolefin-based | 3-41 | 0.0184 | 0.0069 | FDB007 | 0.0323 | 0.0121 |
| | | polymer A | | | | | | |
| Example 811 | 811 | DAC^{c)} | 3-41 | 0.0168 | 0.0096 | N/A | N/A | 0 |
| Comparative | 901 | Cycloolefin-based | N/A | N/A | 0 | N/A | N/A | 0 |
| Example 901 | | polymer A | | | | | | |
| Comparative | 911 | DAC^{c)} | N/A | N/A | 0 | N/A | N/A | 0 |
| Example 911 | | | | | | | | |
| | | | Pigment B | | Pigment A | | | |
| | | d) | Maximum | 10% | Maximum | 10% | b) Light | |
| | | Thick- | absorption | value | absorption | value | resistance | |
| | | ness | wavelength | width | wavelength | width | Dye | Dye |
| | | (μm) | (λmax; nm) | (cm⁻¹) | (λmax; nm) | (cm⁻¹) | B | A |
| | Example 801 | 35 | 598 | 2400 | — | — | 97% | — |
| | Example 802 | 35 | 588 | 2200 | — | — | 95% | — |
| | Example 803 | 35 | 587 | 2200 | — | — | 95% | — |
| | Example 804 | 35 | 598 | 2400 | 496 | 3150 | 97% | 100% |
| | Example 805 | 35 | 598 | 2400 | 490 | 3850 | 97% | 98% |
| | Example 811 | 44 | 585 | 4900 | — | — | 63% | — |
| | Comparative | 35 | — | — | — | — | — | — |
| | Example 901 | | | | | | | |
| | Comparative | 44 | — | — | — | — | — | — |
| | Example 911 | | | | | | | |

a1) Parts by mass with respect to 100 parts by mass of the matrix resin
a2) The content (g/m²) per square meter of polarizing plate protective film
b) Residual percentage after irradiation with 100,000 Lux of xenon for 20 hours
^{c)}Cellulose acetate having a degree of acetyl substitution of 2.4
d) The thickness of the polarizing plate protective film

The results shown in Table 4 show that the polarizing plate protective films 801 to 805 in which the cycloolefin-based polymer was used as the matrix polymer exhibited more favorable light resistance than the inner polarizing plate protective film 811 in which the cellulose acetate was used. Here, the inner polarizing plate protective film refers to a polarizing plate protective film that is disposed closer to a liquid crystal cell than a polarizer in the case of being combined into a liquid crystal display device.

Meanwhile, in the present examples, the light resistance was evaluated for the polarizing plate protective films alone, but these evaluation results impart the same results as the evaluation results of the polarizing plate protective films combined into polarizers or liquid crystal display devices.

<Manufacturing of Polarizing Plates and Manufacturing of Liquid Crystal Display Devices>

1. Production of Polarizing Plate

Pressure-sensitive adhesive-attached polarizing plates 802 to 805 of the present invention and a polarizing plate 901 of a comparative example were manufactured in the same manner as in the production of the polarizing plate 501 except for the fact that, in the production of the polarizing plate 501, the polarizing plate protective films 802 to 805 of the present invention and the polarizing plate protective film 901 of the comparative example were used instead of the polarizing plate protective film 501.

2. Production of Liquid Crystal Display Devices

A pigment filter was removed from a backlight unit of a commercially available liquid crystal television (JS7000FXZA, manufactured by Samsung). Furthermore, a polarizing plate on a backlight side was peeled off, and, instead, the polarizing plate 802 of the present invention was attached thereto through a pressure-sensitive adhesive. A liquid crystal display device 802 of the present invention was manufactured as described above.

As a light source of the liquid crystal television JS7000FXZA, a white LED obtained by combining a blue LED, a green fluorescent body, and a red fluorescent body was used.

The polarizing plates 803 to 805 of the present invention and the polarizing plate 901 of the comparative example were combined into the liquid crystal television JS7000FXZA in the same manner as for the liquid crystal display device 802, thereby manufacturing liquid crystal display devices 803 to 805 and 901 respectively.

<Evaluation of Color Reproduction Ranges and Brightness>

A white color, a red color, a green color, and a blue color were displayed on the full screen of the produced liquid crystal display device, and the brightness of the white display and the chromaticity of each of the red color, the green color, and the blue color were measured using a spectral radiometer: SR-UL2 (trade name, manufactured by Topcon Technohouse Corporation). The area of a portion in which a triangle made by connecting the chromaticity points of the measured red color, green color, and blue color on an xy color diagram of the CIE color system and a triangle made by connecting the three primary color points of the DCI-P3 standard overlapped with each other was obtained, and the area was divided by the area of the triangle made by connecting the three primary color points of the DCI-P3 standard, thereby computing a cover percentage (%) with respect to the DCI-P3 standard. The results are shown in Table 5.

Meanwhile, in the xy color diagram of the CIE color system, the three primary color points of the DCI-P3 standard are as described below respectively.
Red: x=0.680, y=0.320
Green: x=0.265, y=0.690
Blue: x=0.150, y=0.060

In addition, values obtained by dividing the brightness of the white display of the liquid crystal display devices 802 to 805 into which the polarizing plates 802 to 805 of the present invention were combined by the brightness of the white display of the liquid crystal display device 901 in which the polarizing plate 901 of Comparative Example 901 containing no pigments was used were regarded as the relative brightness of the liquid crystal display devices 802 to 805. The results are shown in Table 5.

TABLE 5

| | | DCI-P3 | |
|---|---|---|---|
| | | cover | Relative |
| | | percentage | brightness |
| | Test specimen No. | (%) | (%) |
| Example 802 | Liquid crystal display device 802 | 92.3 | 91.7 |
| Example 803 | Liquid crystal display device 803 | 92.3 | 91.3 |
| Example 804 | Liquid crystal display device 804 | 93.3 | 78.6 |
| Example 805 | Liquid crystal display device 805 | 94.8 | 79.1 |
| Comparative | Liquid crystal display device 901 | 89.5 | 100 |
| Example 901 | | | |

| | | |
|---|---|---|
| Product (liquid crystal television | 92.4 | 78.6 |
| JS7000FXZA) | | |

From the results of Table 5, it is found that all of the liquid crystal display devices 802 to 805 in which the polarizing plates 802 to 805 were used exhibited higher color reproduction ranges than the liquid crystal display device 901 in which the polarizing plate 901 was used. In addition, the liquid crystal display devices 802 and 803 in which the polarizing plate protective film of the present invention was used had a higher brightness than the product in the comparison of the same color range with the product (liquid crystal television JS7000FXZA), which is preferable. In addition, it is found that the liquid crystal display devices 804 and 805 in which the polarizing plate protective films 804 and 805 of the present invention to which not only the dye B but also the dye A were added were used had a wider color range than the product at the same brightness, which is preferable.

The results of the examples and the comparative examples show that the polarizing plates which had a laminate configuration in which the polarizing plate protective film having a thickness of 20 μm or more was laminated on the surface of the polarizer through the adhesive layer and, furthermore, had the dye that absorbs light in a specific wavelength range added to any configurational layer of the laminate and the liquid crystal display devices comprising the polarizing plate had wide color reproduction ranges and high light resistance.

The present invention has been described together with the embodiment, but the present inventors, unless particularly otherwise described, do not intend to limit our invention in any of the details of the description and think that the present invention is supposed to be broadly interpreted within the scope of the concept and scope of the invention described in the claims.

Priority is claimed on JP2016-197613 filed in Japan on Oct. 5, 2016, the content of which is incorporated herein by reference.

### EXPLANATION OF REFERENCES

1: first (upper side) polarizing plate
2: direction of upper side polarizing plate absorption axis
3: first electrode substrate (on liquid crystal cell)
4: orientation control direction of upper electrode substrate
5: liquid crystal layer
6: second electrode substrate (on liquid crystal cell)
7: orientation control direction of lower electrode substrate
8: second (lower side) polarizing plate
9: direction of lower side polarizing plate absorption axis
B: backlight unit
10: liquid crystal display device
20A, 20B: polarizing plate
21: polarizer
22: adhesive layer
23: polarizing plate protective film
70: cast film
85: casting support (band)
89: casting die
120: dope for base layer
121: dope for air-side surface layer
122: dope for support-side surface layer
120a: base layer (core layer)
121a: air-side surface layer (first skin layer)
122a: support-side surface layer (second skin layer)

What is claimed is:

1. A polarizing plate comprising:
a polarizing plate protective film having a thickness of 20 μm or more disposed on both sides or either side of a polarizer through an adhesive layer,
wherein at least one of the polarizer, the polarizing plate protective film, or the adhesive layer contains one or more dyes having a main absorption wavelength range of 480 to 510 nm or 580 to 610 nm.

2. The polarizing plate according to claim 1,
wherein the dye is a squarine-based pigment represented by General Formula (1), 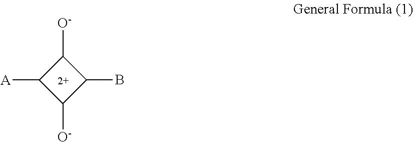
in General Formula (1), A and B each independently represent an aryl group that may have a substituent, a heterocyclic group that may have a substituent, or —CH═G, and G represents a heterocyclic group that may have a substituent.

3. The polarizing plate according to claim 1,
wherein the dye is contained in the polarizing plate protective film.

4. The polarizing plate according to claim 3,
wherein the polarizing plate protective film contains a cellulose acylate polymer.

5. The polarizing plate according to claim 3,
wherein the polarizing plate protective film contains a cycloolefin-based polymer.

6. The polarizing plate according to claim 4,
wherein a content of the dye is 0.001% by mass or more and 1% by mass or less of the cellulose acylate polymer.

7. The polarizing plate according to claim 5,
wherein a content of the dye is 0.001% by mass or more and 1% by mass or less of the cycloolefin-based polymer.

8. A liquid crystal display device comprising:
the polarizing plate according to claim 1 disposed downstream in a light emitting direction of light that is emitted from a backlight unit.
